(19) United States
(12) Patent Application Publication
(10) Pub. No.: US 2015/0321758 A1
(43) Pub. Date: Nov. 12, 2015

(54) UAV deployment and control system

(71) Applicant: Peter Christopher Sarna, II, Clayton, CA (US)

(72) Inventor: Peter Christopher Sarna, II, Clayton, CA (US)

(21) Appl. No.: 14/121,422

(22) Filed: Sep. 2, 2014

Related U.S. Application Data
(60) Provisional application No. 61/872,665, filed on Aug. 31, 2013.

(51) Int. Cl. B64C 39/02

(52) U.S. Cl. CPC B64C 39/024; B64C 2201/08

(57) ABSTRACT

A system of software and hardware components is disclosed comprising a system designed to deploy, manage, and control unmanned aerial vehicles (UAVs). The integrated UAVs can be deployed from vehicles, buildings, and other types of fixed locations. The present disclosure enables users to deploy UAVs to perform pre-defined flight maneuvers and fly to pre-designated locations. The present disclosure also and affords the ability for users to maintain the UAVs flight control locally or transfer control of a deployed UAV to remotely located system operators.

### PRIORITY

This disclosure claims priority to U.S. Provisional Patent Application No. 61/872,665 filed Aug. 31, 2013 entitled “UAV Deployment and Control System” herein incorporated by reference in its entirety.

### BACKGROUND

Unmanned aerial vehicles (UAVs) are defined as aircraft capable of flying without a human pilot. UAVs have the ability to be controlled autonomously using computer software or manually using remote control technology.

Unmanned aerial vehicles are also commonly referred to as remotely piloted vehicles (RPVs) as well as unmanned aircraft systems (UAS).

UAVs can be manufactured in a wide-range of shapes, sizes and configurations and can be designed to employ a variety of components ranging from on-board camera systems to radiological sensors. UAVs are also capable of using a number of different types of flight mechanisms: rotary or propeller systems, jet engine propulsion, or the use of lifting gasses such as helium or hydrogen.

The use of UAVs is becoming more prevalent in a large number of industries. While historically used for military applications, UAVs are used to support public safety agencies, fire departments, search and rescue operations, wildlife research, scientific research, agriculture, meteorology, aerial mapping, and pollution monitoring.

UAVs offer less expensive alternatives to manned aircraft such as helicopters and can perform tasks that may be dangerous or impractical for traditional aircraft to perform.

### SUMMARY

The present disclosure is a combination of integrated software and hardware components comprising a system designed to deploy, manage, and control unmanned aerial vehicles (UAVs).

UAVs integrated to function with the present disclosure can be deployed from vehicles, buildings, and other types of fixed locations. The present disclosure allows UAVs to remain fully charged and protected while not in use.

The present disclosure enables users to deploy UAVs to perform pre-defined flight maneuvers and fly to pre-designated locations at the time of launch using the present disclosures software user interface.

The present disclosure can be configured to function with the assistance of computer aided dispatch (CAD) software systems to assist with the deployment of integrated UAVs.

The present disclosure enables users to maintain the flight control functions of integrated UAVs locally, or transfer control of a deployed UAV to system operators located remotely. Once transferred, control of the deployed UAV can be returned to the original operator or transferred to another available system user.

UAVs integrated to function with the present disclosure can be deployed locally from a vehicle, building, or fixed objects under control of users in close proximity to the UAV or by system operators located at remote locations.

Software and hardware components are used to determine if a UAV configured to function with the present disclosure can be successfully launched from a moving vehicle designed to transport the UAV.

### BRIEF DESCRIPTION OF THE DRAWINGS

FIG. 01 is a top-view illustration showing an example of an unmanned aerial vehicle (UAV).

FIG. 02 is a front-view illustration showing an example of an unmanned aerial vehicle configured to operate with the present disclosure.

FIG. 03 is a diagram illustration showing examples of electronic components utilized by one or more of the present disclosure's unmanned aerial vehicles.

FIG. 04 is a diagram illustration showing examples of the types of microchips utilized by one or more of the present disclosure's unmanned aerial vehicles.

FIG. 05 is a diagram illustration showing the types of camera systems utilized by one or more of the intention's unmanned aerial vehicles.

FIG. 06 is an illustration of one of the present disclosure's UAV containers comprising a portion of the present disclosure designed to secure and protect one or more of the present disclosure's unmanned aerial vehicles.

FIG. 07 is a top-view illustration of one of the present disclosure's UAV containers that has been opened to allow the launch of one of the present disclosure/s unmanned aerial vehicles.

FIG. 08 is a top-view illustration of one of the present disclosure's UAV containers that has been opened allowing the interior data, power, and electrical connectors to be viewed.

FIG. 09 is a bottom-view illustration of one of the present disclosure's UAV containers allowing the data, power, and electrical cables/wiring to be viewed.

FIG. 10 is a flowchart illustration showing the components and their related functions comprising the present disclosure.

FIG. 11 is a flowchart illustration showing the process of launching a UAV and the determination of flight control.

FIG. 12 is a flowchart illustration showing the present disclosure's process of evaluating speed as a factor in determining the ability to deploy one of the present disclosure's UAVs from a moving vehicle.

FIG. 13 is a flowchart illustration showing actions comprising the present disclosure's ability to launch integrated UAVs with pre-determined flight control options.

FIG. 14 is an illustration showing the present disclosure's ability to monitor and remotely control multiple integrated UAVs.

FIG. 15 is an illustration showing the graphical user interface utilized by present disclosure operators to launch an integrated UAV with pre-determined flight control options.

FIG. 16 is an illustration showing the graphical user interface utilized by present disclosure operators to select UAV deployment options using map based or pre-determined flight destinations.

FIG. 17 is an illustration showing the graphical user interface utilized by present disclosure operators to select and deploy an integrated UAV to a pre-determined flight destination stored in the present disclosure's database.

FIG. 18 is an illustration showing the graphical user interface utilized by present disclosure operators to deploy an integrated UAV to a destination by selecting the defined area of a map integrated with parcel line boundaries.

FIG. 19 is an illustration showing the graphical user interface utilized by present disclosure operators to deploy an integrated UAV to a selected location using cursor placement.

FIG. 20 is an illustration showing the cursor design of the graphical user interface utilized to deploy an integrated UAV to a selected location and to determine camera orientation upon arrival at the location.

FIG. 21 is an illustration showing one of the present disclosure's UAV containers installed on the trunk area of a vehicle.

FIG. 22 is an illustration showing one of the present disclosure's UAV containers installed on the trunk area of a vehicle that has been opened to allow the deployment of an integrated UAV.

FIG. 23 is an illustration showing one of the present disclosure's UAV containers installed on the trunk area of a vehicle that has been opened. The integrated UAV has been deployed and is beginning to fly in an upward direction.

FIG. 24 is an illustration showing one of the present disclosure's UAV containers installed on the trunk area of a vehicle that has been opened. The integrated UAV has been deployed and is following the moving vehicle.

FIG. 25 is an illustration showing a neighborhood where an integrated UAV has been deployed from a vehicle and is being controlled to follow a fleeing person.

FIG. 26 is an illustration showing a commercial building where an integrated UAV has been deployed from a rooftop container. The UAV is being controlled to follow a fleeing person.

FIG. 27 is an illustration showing the graphical user interface utilized by present disclosure operators to access the present disclosure's components and functions and prevent unauthorized persons from accessing the present disclosure.

FIG. 28 is an illustration showing the graphical user interface utilized by present disclosure operators to view an integrated UAV camera display and monitor data associated with an integrated UAV deployment.

FIG. 29 is an illustration showing a portion of the graphical user interface utilized by present disclosure operators to monitor data associated with an integrated UAV deployment.

FIG. 30 is an illustration showing the dropdown menu option of the graphical user interface to monitor data associated with an integrated UAV deployment and perform additional integrated UAV control functions.

FIG. 31 is an illustration showing the dropdown menu option of the graphical user interface with examples of integrated UAV control functions.

FIG. 32 is an illustration showing an alert displayed by the graphical user interface to notify present disclosure operators that an integrated UAV has been deployed and that they are being requested to assume remote control of the UAVs flight control functions.

FIG. 33 is an illustration showing a prompt displayed by the graphical user interface confirming that an present disclosure operator desires to transfer the flight control functions to another present disclosure operator.

FIG. 34 is an illustration showing the graphical user used to view an integrated UAVs camera display and to a person or vehicle to be automatically followed by a deployed UAV.

FIG. 35 is an illustration showing an alert displayed by the graphical user interface to notify present disclosure operators that the battery providing power to a deployed UAV has reached a predetermined power providing capacity.

FIG. 36 is an illustration example of an integrated handheld controller that can be used by present disclosure users to control the flight functions of an integrated and deployed UAV.

FIG. 37 is an illustration example of an integrated handheld controller with additional command buttons that can be used by present disclosure users to control the flight functions of an integrated and deployed UAV.

FIG. 38 is an illustration example of an integrated handheld controller with an integrated, touch-screen video display capable of displaying the graphical user interface utilized by present disclosure operators to view the camera display and data associated with an integrated UAV deployment.

FIG. 39 is an illustration of the graphical user interface used by personnel with access to the present disclosure to view, but not control, the camera display and data associated with an integrated UAV deployment.

FIG. 40 is an illustration of the graphical user interface used by personnel to monitor the relative positions and status of integrated UAV systems installed on vehicles or at fixed locations such as building rooftops.

FIG. 41 is an illustration of the graphical user interface used by personnel to monitor the relative positions and status of integrated UAV systems installed on vehicles or at fixed locations such as building rooftops. The user has selected a UAV for flight deployment and a prompt is being displayed to confirm the launch function.

FIG. 42 is a flowchart illustration showing the present disclosure's functions and processes that allow a remote user to select and deploy an integrated UAV.

FIG. 43 is a flowchart illustration showing the process by which a request to assume control of a deployed UAV is handled by the present disclosure.

FIG. 44 is an illustration showing the integration and ability for an external data system (Computer Aided Dispatch) to provide pre-determined flight destinations.

FIG. 45 is an illustration of the graphical user interface used to display the flight restrictions and parameters of integrated UAVs within defined geographical areas.

### DETAILED DESCRIPTION

This present disclosure relates generally to the deployment, management, and control of unmanned aerial vehicles (UAVs). The present disclosure's integrated UAVs can be deployed from vehicles, buildings, and other types of fixed locations.

The following description is presented to enable one having ordinary skill in the art to make and use the embodiment and is provided in the context of a patent application. The generic principles and features described herein will be apparent to those skilled in the art. Thus, the present embodiment is not intended to be limited to the embodiments shown, but is to be accorded the widest scope consistent with the principles and features described herein.

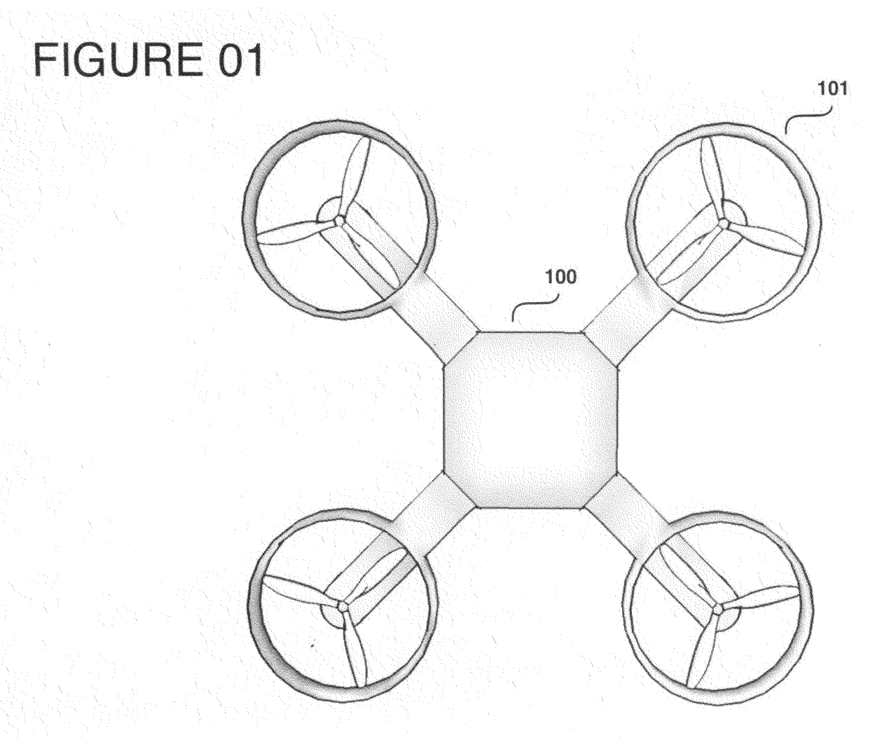

FIG. 01 is a top-view illustration showing an example of an unmanned aerial vehicle (UAV) configured to operate with the present disclosure. UAVs comprising the flight component of the present disclosure can be any size depending on the needs and operational requirements of the present disclosure's user(s). UAVs integrated to operate with the present disclosure require a frame and housing 100 for the purpose of protecting electronic components, a power source, and onboard equipment, and an aerial propulsion system 101 designed to allow the UAV to fly through the air. UAVs integrated to function with the present disclosure can utilize, but are not limited to the following propulsion systems: rotary or propeller systems, jet engine propulsion, or the use of lifting gasses such as helium or hydrogen.

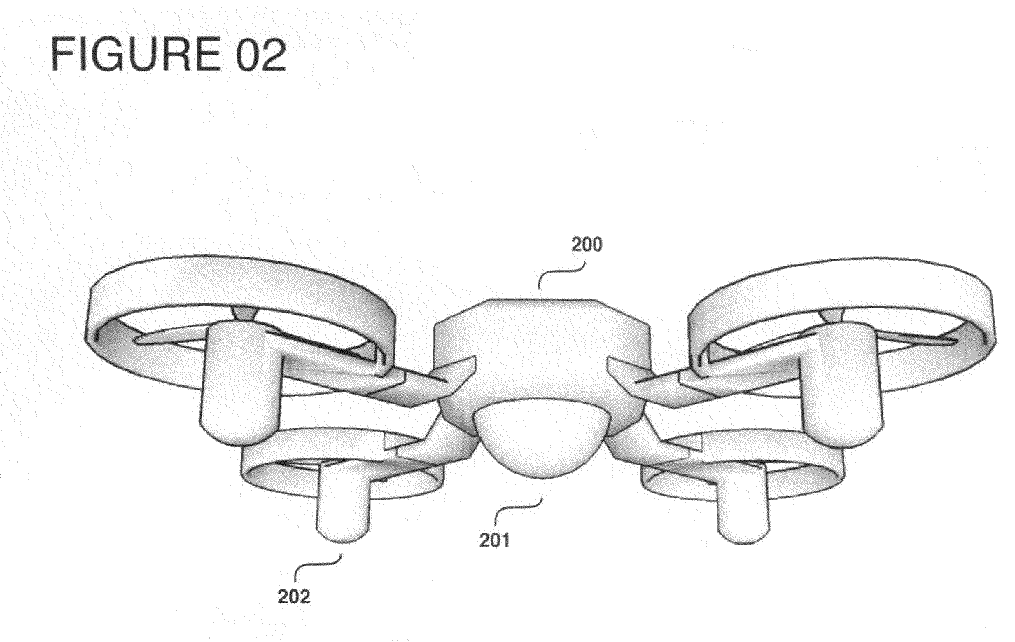

FIG. 02 is a front-view illustration showing an example of an unmanned aerial vehicle 200 configured to operate with the present disclosure. UAVs comprising the flight component of the present disclosure can be constructed to remotely operate equipment such as, but not limited to camera systems 201, spotlights, and audio transmission components. UAVs configured to operate with the present disclosure can be constructed with contact charging, and data transmission mechanisms 201, designed to operate when the UAV is placed upon a receiving contact charging and/or data transmission mechanism.

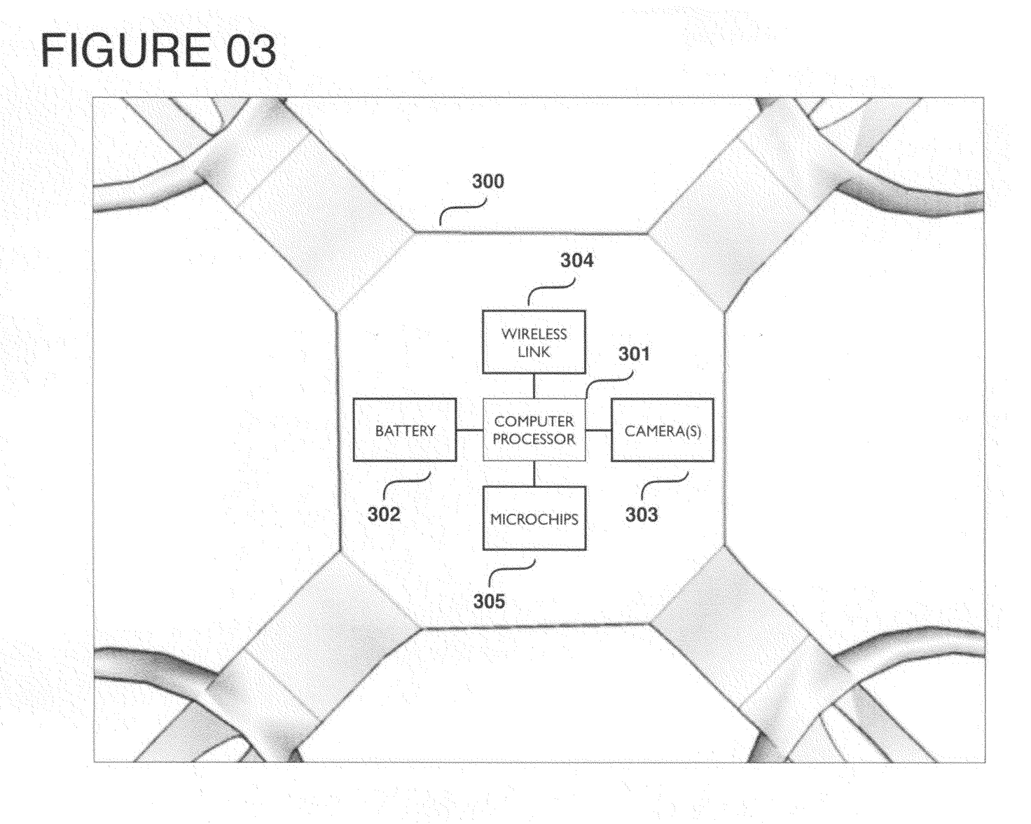

FIG. 03 is a diagram illustration showing examples of components utilized by one or more of the present disclosure's UAVs 300. Types of components can include, but are not limited to computer processors 301, batteries and/or other types of power/fuel sources 302, cameras 303, and wireless communications processors 304 allowing remote control of the UAV and its onboard equipment. The type of wireless communication systems used by UAVs configured to operate with the present disclosure can include, but are not limited to, radio, microwave, cellular, and Wi-Fi technologies. Additional components can include chemical, biological, and radiation detectors.

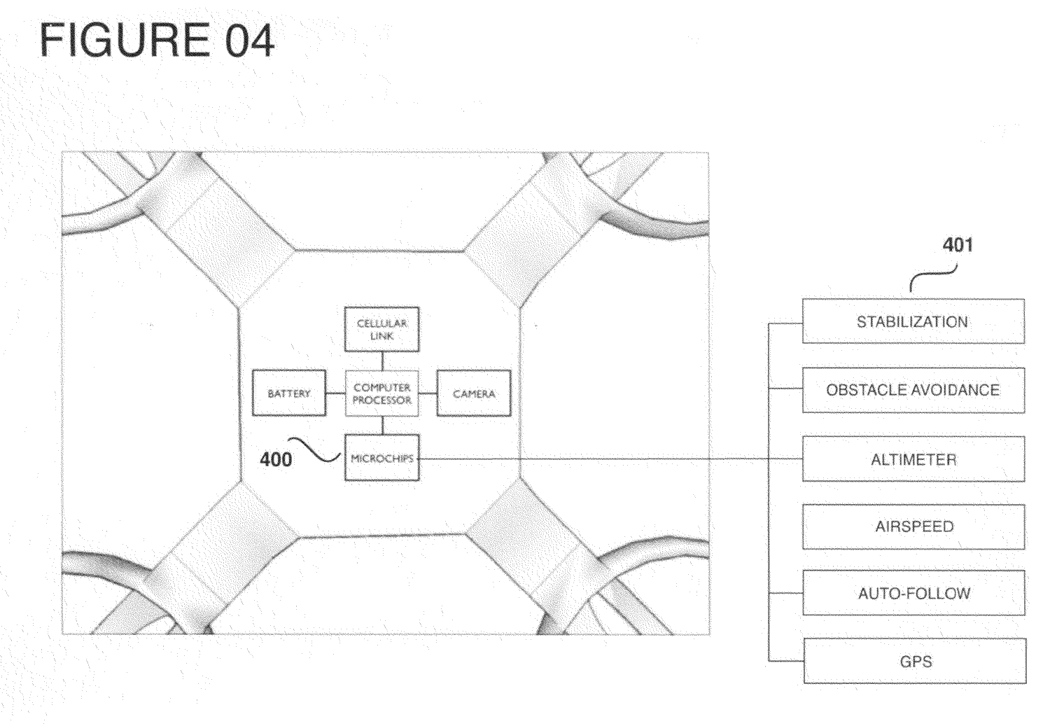

FIG. 04 is a diagram illustration showing examples of the types of microchips utilized by one or more of the present disclosure's unmanned aerial vehicles 400. Types of microchips used to control and enhance the flight capabilities of UAVs configured to operate with the present disclosure can include, but are not limited to, stabilization and obstacle avoidance systems, altitude and airspeed sensors, object/person recognition and following systems, and global positioning location technology (GPS) 401.

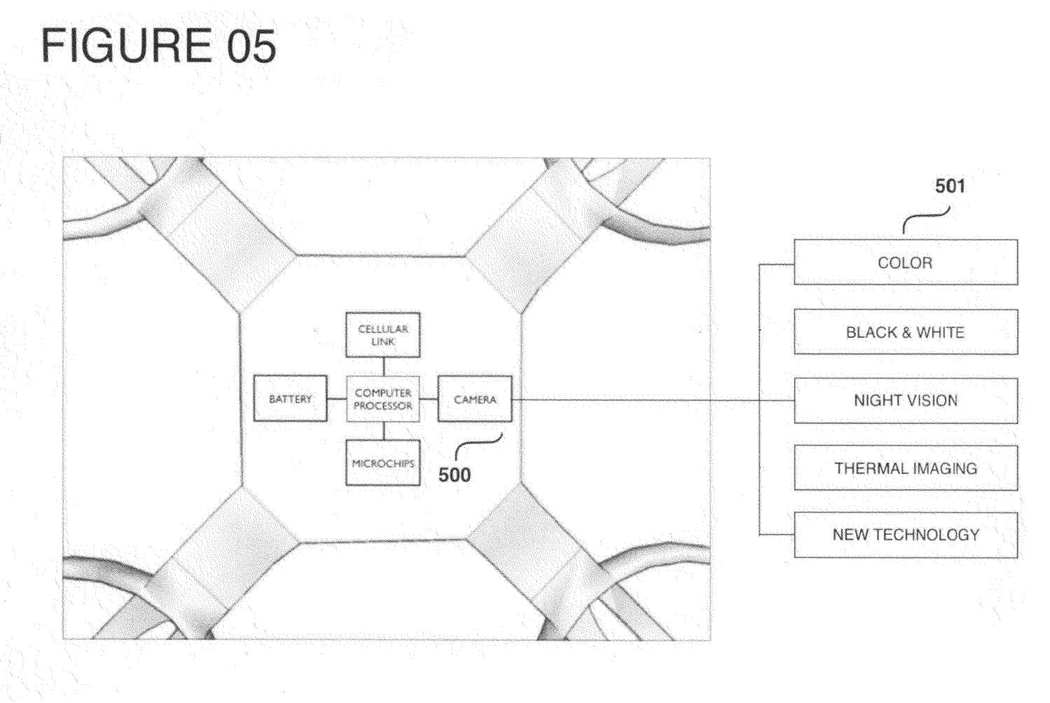

FIG. 05 is a diagram illustration showing the types of camera systems 500 utilized by one or more of the intention's UAVs. The types of camera systems utilized can include, but are not limited to digital color and black and white systems, night vision, and thermal imaging.

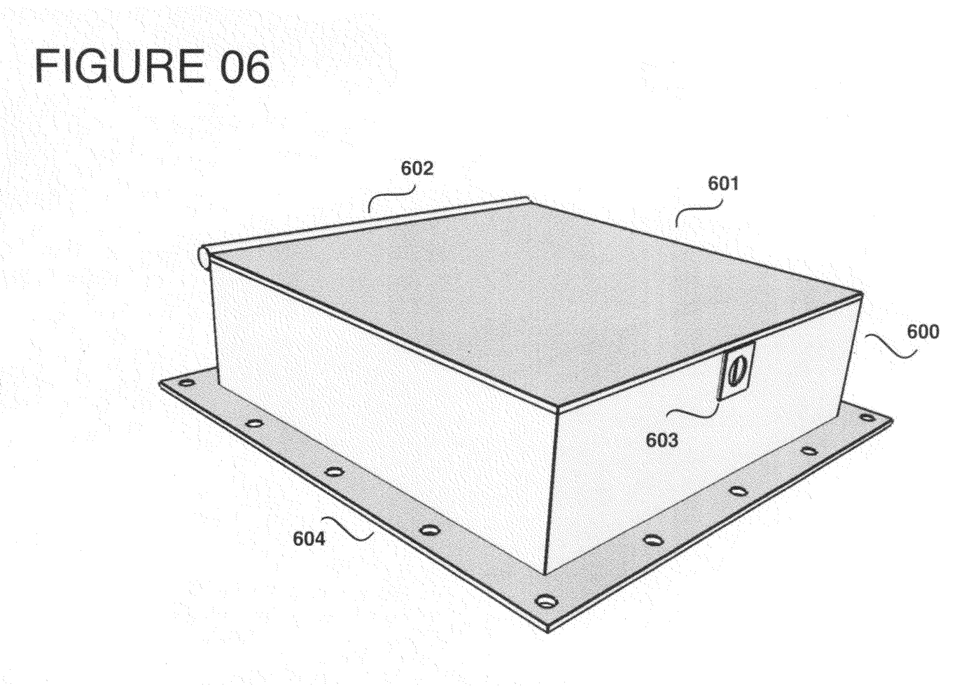

FIG. 06 is an illustration of one of the present disclosure's UAV containers comprising a portion of the present disclosure designed to secure and protect one or more of the present disclosure's unmanned aerial vehicles. The component's comprising the present disclosure's UAV containers includes, but is not limited to the following construction elements: a housing 600 designed to protect the UAV from theft, damage, moisture, heat, dirt, weather elements, a door or lid component 601 designed to open and allow the UAV to be deployed from inside the container, a hinge or other similar mechanism 602 designed to open the door or lid, a lock mechanism 603 that allows the container door or lid to be opened both remotely and locally, and a component that allows the container to be secured to a vehicle, fixed object, or building 603.

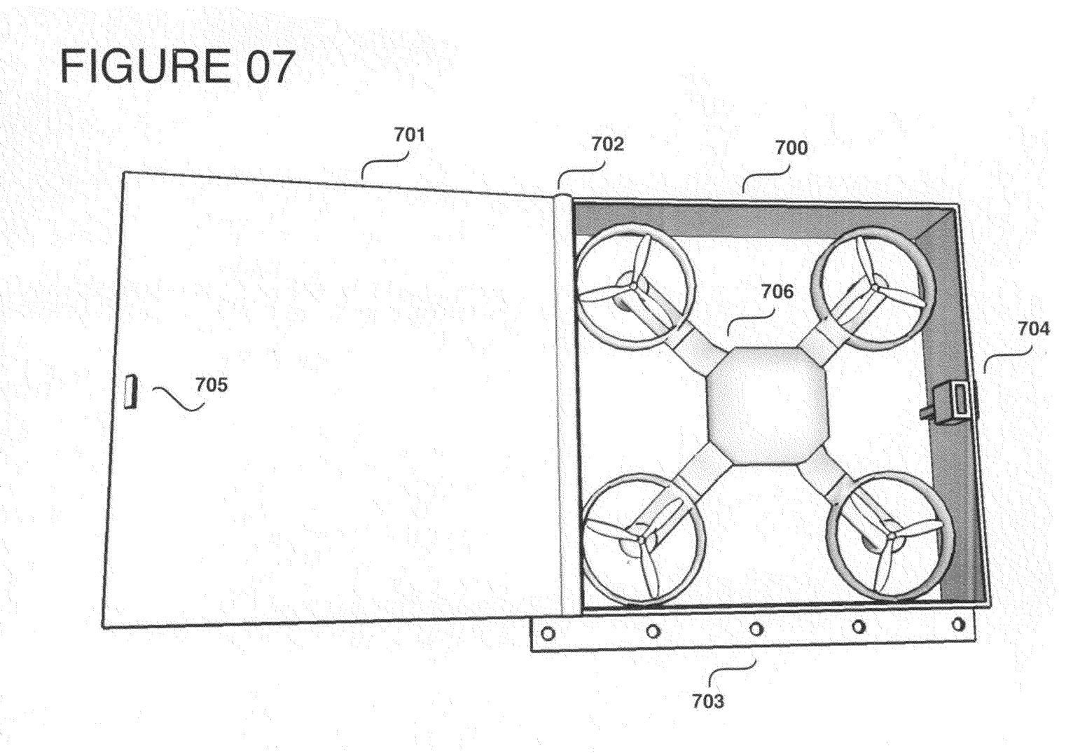

FIG. 07 is a top-view illustration of one of the present disclosure's UAV containers that has been opened to allow the launch of one of the present disclosure/s unmanned aerial vehicles 700. The illustration shows the door or lid in the open position 701, a hinge mechanism 702, a mounting bracket 703, a locking mechanism 704, 705, and a UAV configured to operate with the present disclosure 706 inside the present disclosure's container. The hinge or opening mechanism 702 utilized by the present disclosure can be used to open the door or lid 701 using, but not limited to the following methods: spring-loaded mechanisms, gravity, or power driven devices.

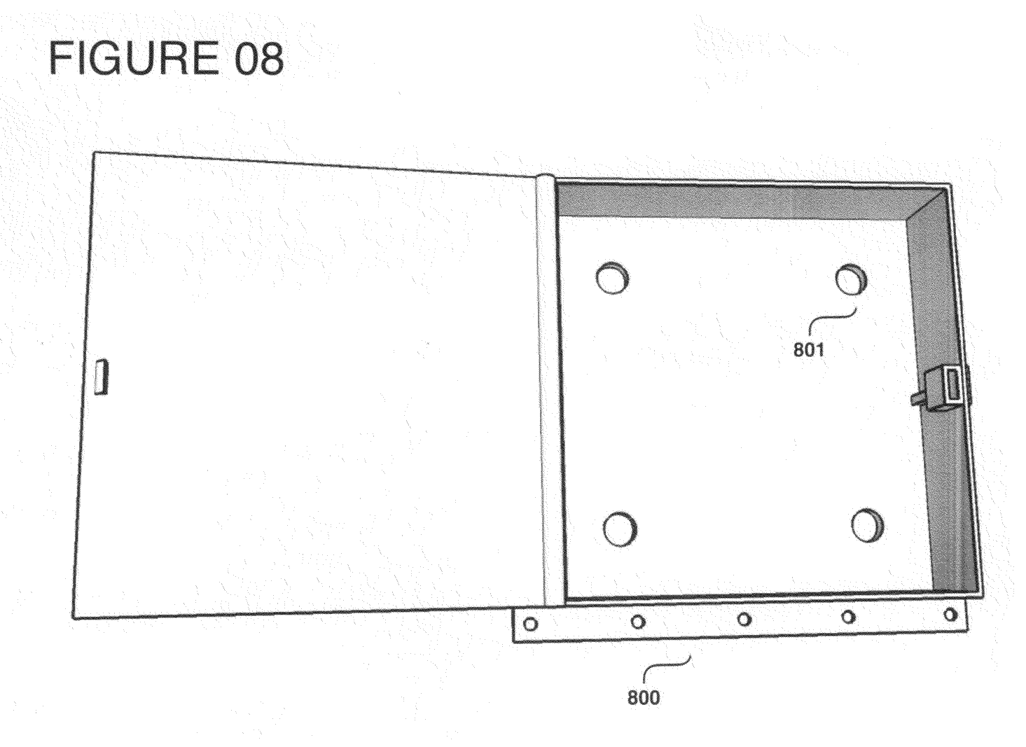

FIG. 08 is a top-view illustration of one of the present disclosure's UAV containers 800 that has been opened allowing the interior data, power, and electrical connectors 801 to be viewed. The present disclosure's UAV containers are constructed with components allowing integrated UAVs to remain fully charged, receive data, and other electrical connections while resting in one of the present disclosure's UAV containers. The connectors 801 do not impede the ability for an integrated UAV to be deployed and do not require the UAV to be manually disconnected.

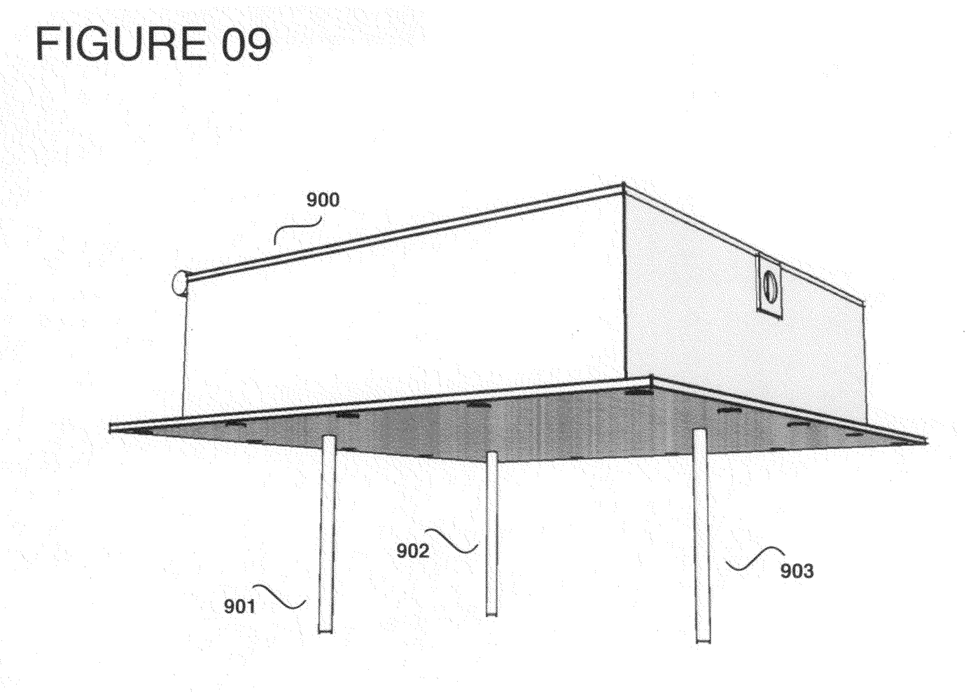

FIG. 09 is a bottom-view illustration of one of the present disclosure's UAV containers 900 allowing the data 901, power 902, and electrical cables/wiring 903 to be viewed. The cables and wiring allow the UAV container to be attached to other present disclosure components when mounted to a vehicle, fixed object, or building.

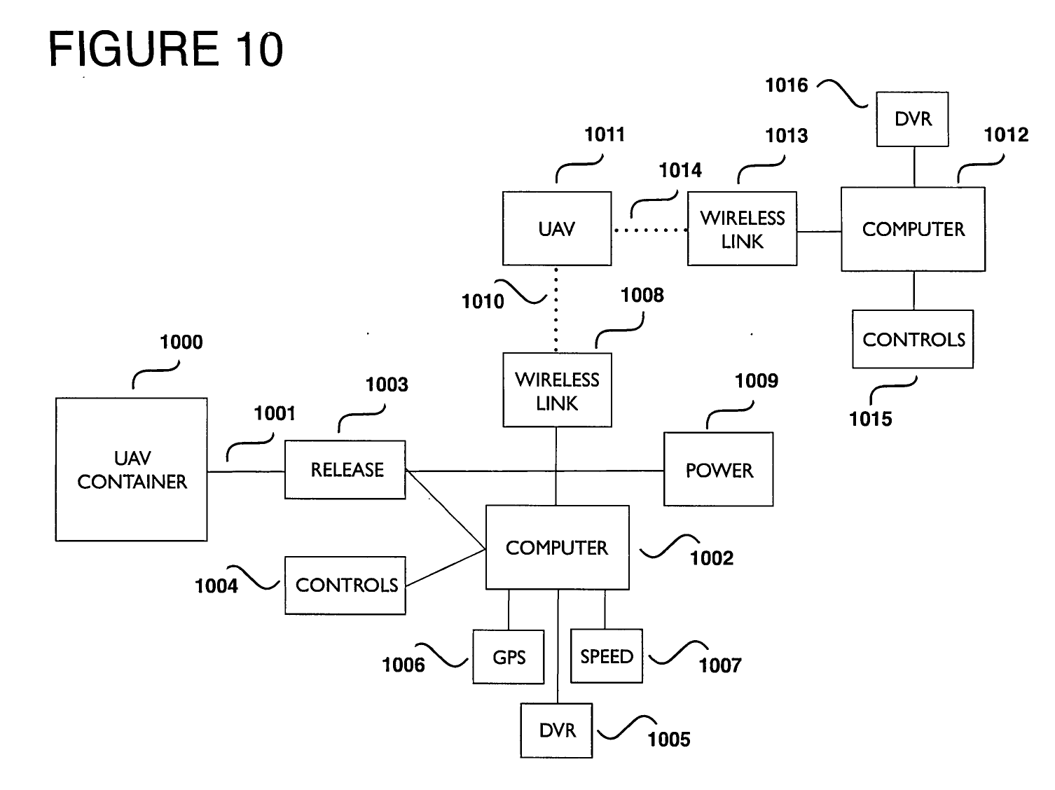

FIG. 10 is a flowchart illustration showing the components and their related functions comprising the present disclosure. Two distinct operational elements comprise the present disclosure: one or more integrated UAVs contained in a protective housing (container) mounted on a vehicle, fixed object, or building that can be operated locally 1000-1011, and a system of components that allows the same integrated UAVs to be deployed and controlled remotely 1012-1016.

As stated, the first operational element consists of one or more integrated UAVs contained in a protective container 1000, each of which is connected 1001 (wired or wirelessly) to a computer 1002 which controls a UAV release mechanism 1003 and system controls 1004. The computer is connected to additional components to include, but not limited to a digital video recorder (DVR) 1005, GPS 1006, and a speedometer 1007 (when the aforementioned components are mounted to a vehicle). A wireless data communication device 1008 and components 1000-1006 are connected to a power source 1009. The wireless communication device 1008 transmit wireless signals 1010 that allows an integrated UAV 1011 to be controlled while in flight.

The second system of operational components 1012-1016 allows integrated UAVs to be deployed and controlled remotely. One or more server-based computers 1012 utilize a wireless communication device 1013 to transmit wireless signals 1014 that enable integrated UAVs 1011 to be deployed and controlled remotely using remote control mechanisms 1015. An integrated DVR 1016 allows digital camera images from a controlled UAV to be recorded.

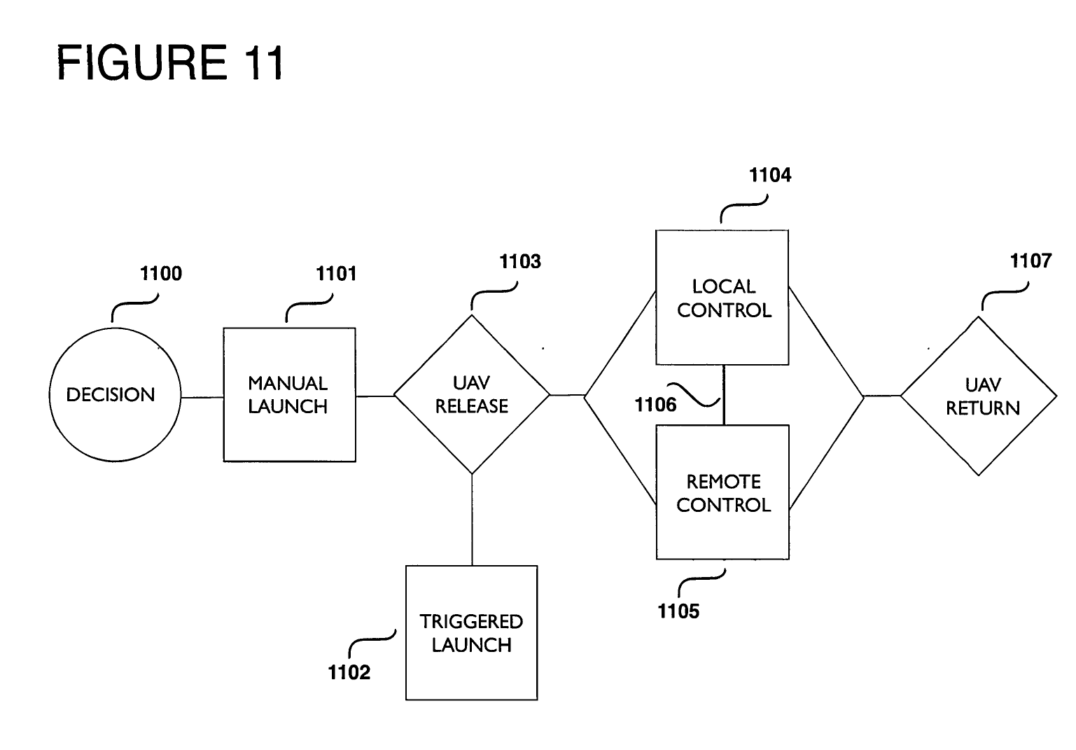

FIG. 11 is a flowchart illustration showing the process of launching a UAV and the determination of flight control. UAVS integrated with the present disclosure can be launched using two distinct methods: Users can make the decision 1101 to initiate a manual launch 1101, or the present disclosure can be prompted to initiate an automated launch 1102 which is triggered by an event. Examples of events that can trigger an automated launch can include, but are not limited to, robbery alert buttons, motion detection devices, and changes in data readings from a monitoring device.

The manual decision 1101 to launch an integrated UAV 1101, includes the decision to maintain flight control of the UAV from the location from which it was launched 1104, or the UAV can be directed to perform an automated flight pattern until control is assumed by a remote operator 1105. Once deployed, the ability to control an airborne UAV can be exchanged 1106. Upon completion of the deployment, the controlling operator can direct the UAV to return to its original launch point, a predetermined location, or manually direct it to an alternate location for landing 1107.

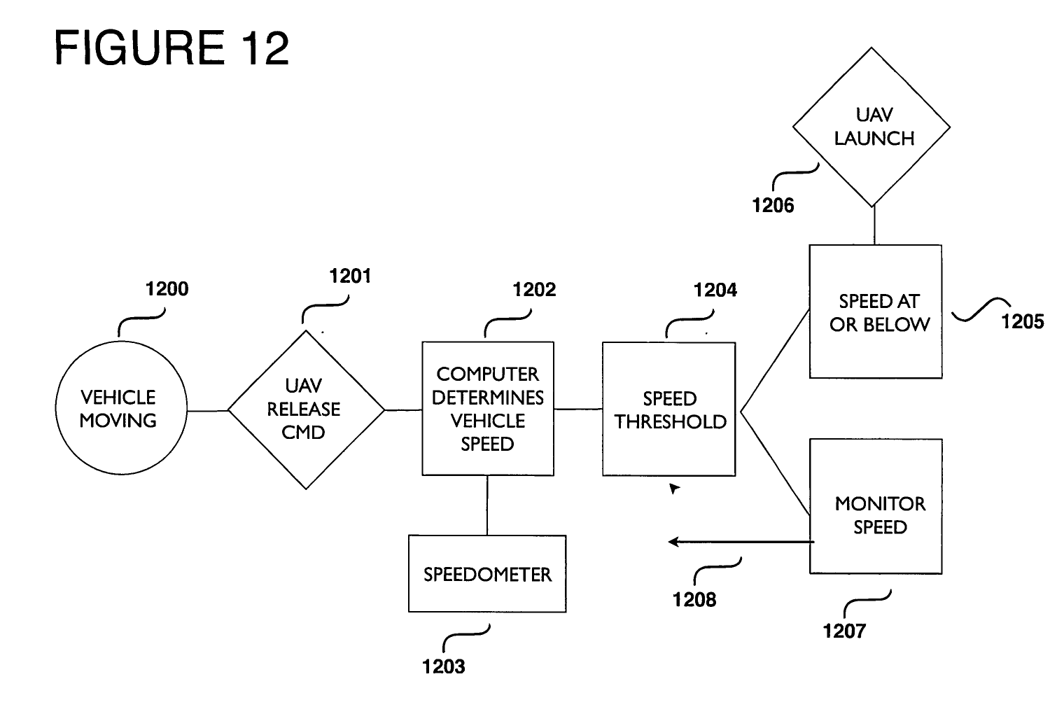

FIG. 12 is a flowchart illustration showing the present disclosure's process of evaluating speed as a factor in determining the ability to deploy one of the present disclosure's integrated UAVs from a moving vehicle 1200. When the determination has been made to launch an integrated UAV from a moving vehicle 1201, the present disclosures computer processor 1202 will determine the vehicle's current speed 1203 and measures it against a speed threshold 1204 to determine if the deployment of an integrated UAV will occur. The speed threshold can be manually adjusted, as different types of integrated UAVs will have wide range of performance tolerances that will determine whether or not they can be successfully launched from a moving vehicle. If the computer processor 1202 determines that the vehicle's speed is at or below the predetermined speed threshold 1205, the integrated UAV will be deployed 1206. If the computer processor 1202 determines that the vehicle's speed is above the predetermined speed threshold, the computer processor will continue to monitor the vehicle's speed 1207 until it has dropped below the speed threshold 1205 and then deploy the UAV 1206. Other factors can also be used to govern UAV deployments. Additional factors that can me evaluated using monitoring devices to determine if the performance specifications of an integrated UAV will likely result in a successful launch are, but not limited to, wind speed, weather conditions, and the inclination or declination levels of a vehicle's patch of travel. Additionally, object sensing devices can be utilized in proximity to the UAVs launch container to determine if any object is above the location that will impede a successful airborne deployment.

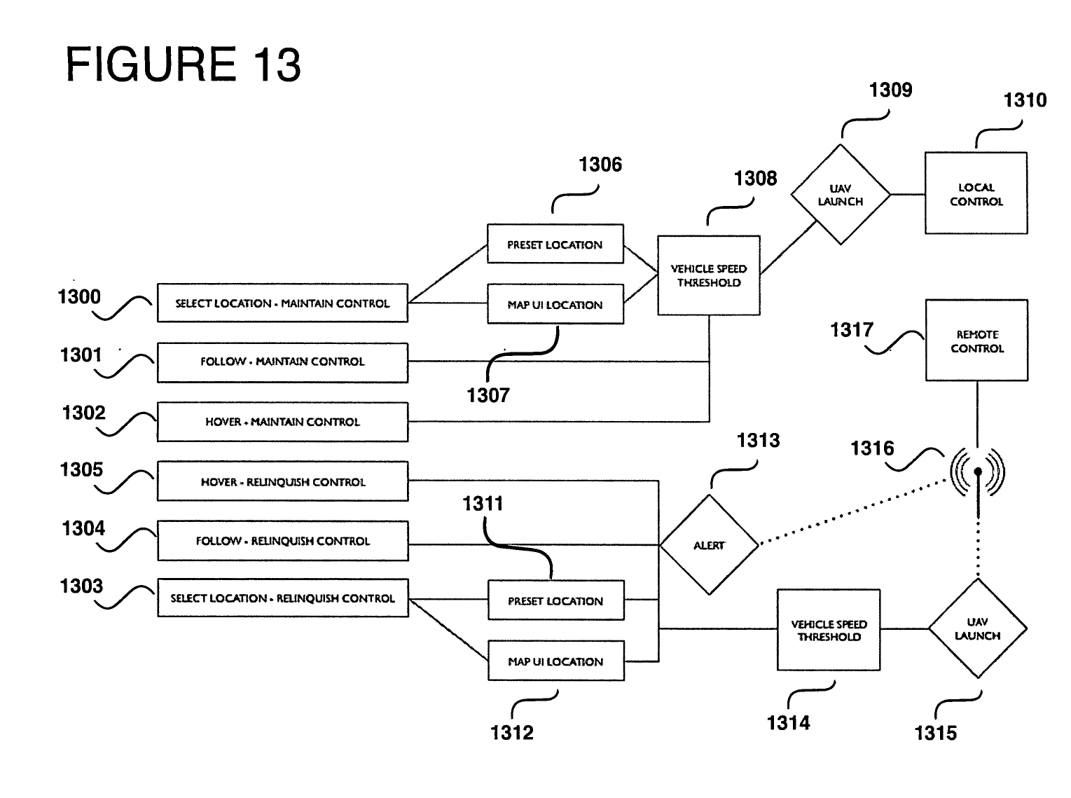

FIG. 13 is a flowchart illustration showing actions comprising the present disclosure's ability to launch integrated UAVs with pre-determined flight control options. When the decision has been made to deploy and integrated UAV whether manually, or triggered by an event, the present disclosure can direct the UAV to perform an automated flight sequence and determine flight control parameters. Flight control can be assigned either locally (from the deployment location) 1300-1302, or from a remote control point 1303-1305.

The decision to deploy an integrated UAV to a pre-determined location and maintain local control 1300, allows users to deploy an integrated UAV to fly to a predetermined location stored in the present disclosure's computer processor 1306 or to a specific location using integrated mapping software 1307. If launched from a vehicle, the computer processor will determine if current factors that can affect the launch (see FIG. 12) are within limits and deploy the UAV 1309. Once the UAV has arrived at its predetermined destination, it will hover in place until the deploying operator assumes flight control of the UAV 1310.

The decision can also be made to deploy an integrated UAV that will follow the vehicle it was deployed from at a predetermined altitude or an altitude that will adjust to preprogrammed parameters 1301. The computer processor will determine if current factors that can affect the launch 1308 (see FIG. 12) are within limits and deploy the UAV 1309. The deployed UAV will continue to follow the vehicle from which it was launched until the deploying operator assumes flight control of the UAV 1310.

The decision can also me made to deploy an integrated UAV to hover in place at a predetermined altitude or an altitude determined by preprogrammed parameters above the location from which it was launched. If launched from a vehicle, the computer processor will determine if current factors that can affect the launch (see FIG. 12) are within limits and deploy the UAV 1309. The deployed UAV will hover in place until the deploying operator assumes flight control of the UAV 1310.

The decision to deploy an integrated UAV to a pre-determined location and relinquish control 1303, allows users to deploy an integrated UAV to fly to a predetermined location stored in the present disclosure's computer processor 1311 or to a specific location using integrated mapping software 1312. The computer processor will determine if current factors that can affect the launch (see FIG. 12) are within limits and deploy the UAV 1309. Upon deployment, an alert 1313 will be sent to remote monitoring computers(s) 1316 notifying operators that remote control of the deployed UAV has been requested. Once the UAV has arrived at its predetermined destination, it will hover in place until the deploying operator assumes flight control of the UAV 1317.

The decision can also be made to deploy an integrated UAV that will follow the vehicle from which it was deployed until flight control is assumed by a remote operator 1303. The computer processor will determine if current factors that can affect the launch 1314 (see FIG. 12) are within limits and deploy the UAV 1315. Upon deployment, an alert 1313 will be sent to remote monitoring computers(s) 1316 notifying operators that remote control of the deployed UAV has been requested. The deployed UAV will continue to follow the vehicle from which it was launched until a remote operator assumes flight control of the UAV 1317.

The decision can also me made to deploy and integrated UAV to hover in place at a predetermined altitude or an altitude determined by preprogrammed parameters above the location from which it was launched. If launched from a vehicle, the computer processor will determine if current factors that can affect the launch 1314 (see FIG. 12) are within limits and deploy the UAV 1315. Upon deployment, an alert 1313 will be sent to remote monitoring computers(s) 1316 notifying operators that remote control of the deployed UAV has been requested. The deployed UAV will hover in place until the deploying operator assumes flight control of the UAV 1317.

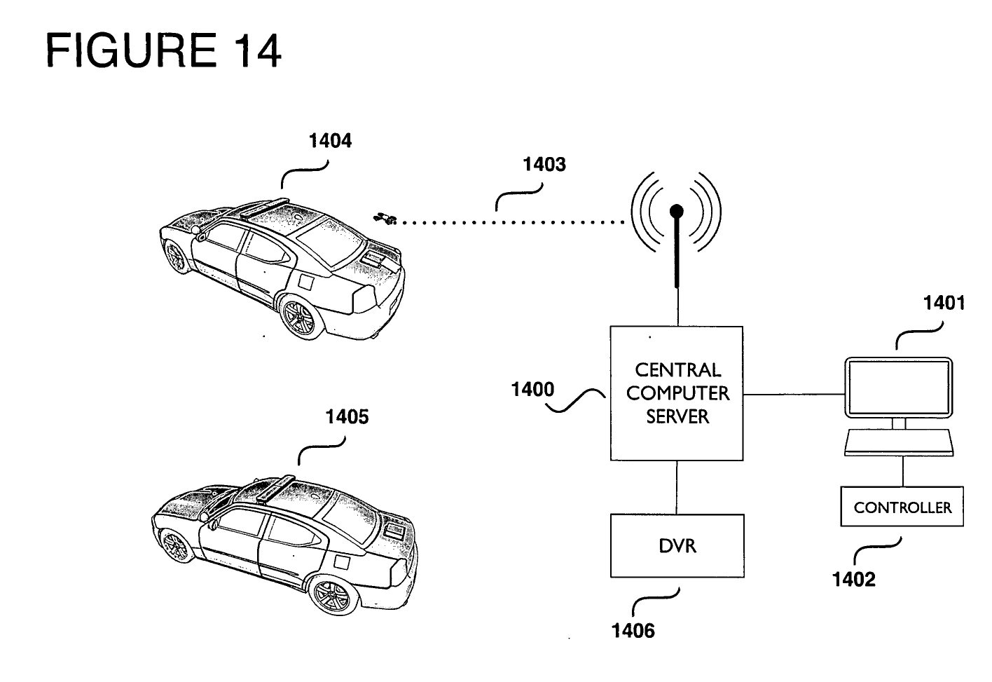

FIG. 14 is an illustration showing the present disclosure's ability to monitor and remotely control multiple integrated UAVs. The present disclosure's central computer server 1400 can be linked to one or more computer terminals 1401 with system controls 1402, each capable of remotely piloting integrated UAVs using wireless data transmissions 1403. FIG. 14 shows a vehicle deployed UAV 1404 being controlled by a remote computer terminal 1401. An additional vehicle carrying an integrated UAV 1405 is linked to the system but the UAV has not been deployed.

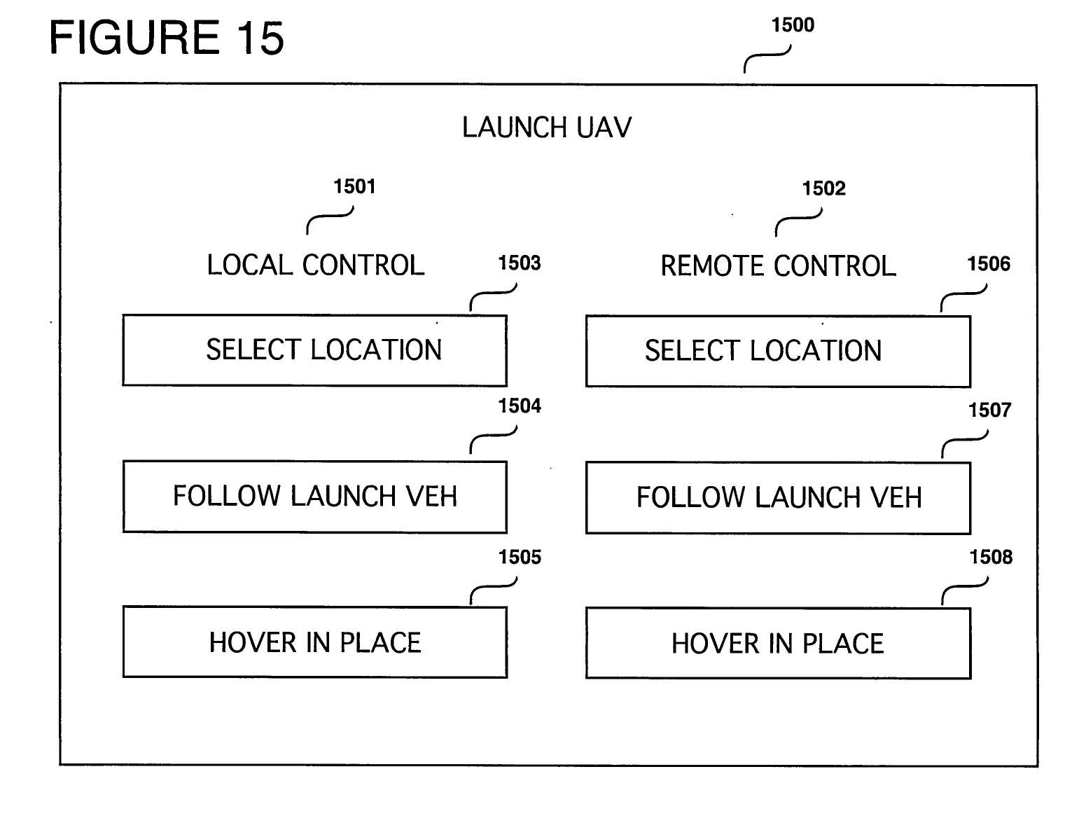

FIG. 15 is an illustration showing the graphical user interface 1500 utilized by present disclosure operators to launch an integrated UAV with pre-determined flight control options. The launch options are separated into two distinct groups, one where local flight control of the UAV is maintained 1501, and a second where remote flight control is requested 1502.

The user can deploy an integrated UAV to a pre-determined location and maintain local control of the deployed UAV using selection 1503. The components and processes comprising this option are detailed in FIG. 13 (1300, 1306-1310).

The decision can also be made to deploy an integrated UAV that will follow the vehicle from which it was deployed at a predetermined altitude or an altitude that will adjust to preprogrammed parameters using selection 1504. The components and processes comprising this option are detailed in FIG. 13 (1301, 1306-1310).

The decision can also me made to deploy and integrated UAV to hover in place at a predetermined altitude or an altitude determined by preprogrammed parameters above the location from which it was launched using selection 1505. The components and processes comprising this option are detailed in FIG. 13 (1302, 1306-1310).

The user can deploy an integrated UAV to a pre-determined location and request remote control of the deployed UAV using selection 1506. The components and processes comprising this option are detailed in FIG. 13 (1303, 1311-1316).

The decision can also be made to deploy an integrated UAV that will follow the vehicle from which it was deployed at a predetermined altitude or an altitude that will adjust to preprogrammed parameters using selection 1507. This option also requests remote control of the deployed UAV. The components and processes comprising this option are detailed in FIG. 13 (1304, 1311-1316).

The decision can also me made to deploy and integrated UAV to hover in place at a predetermined altitude or an altitude determined by preprogrammed parameters above the location from which it was launched using selection 1508. This option also requests remote control of the deployed UAV. The components and processes comprising this option are detailed in FIG. 13 (1305, 1306-1310).

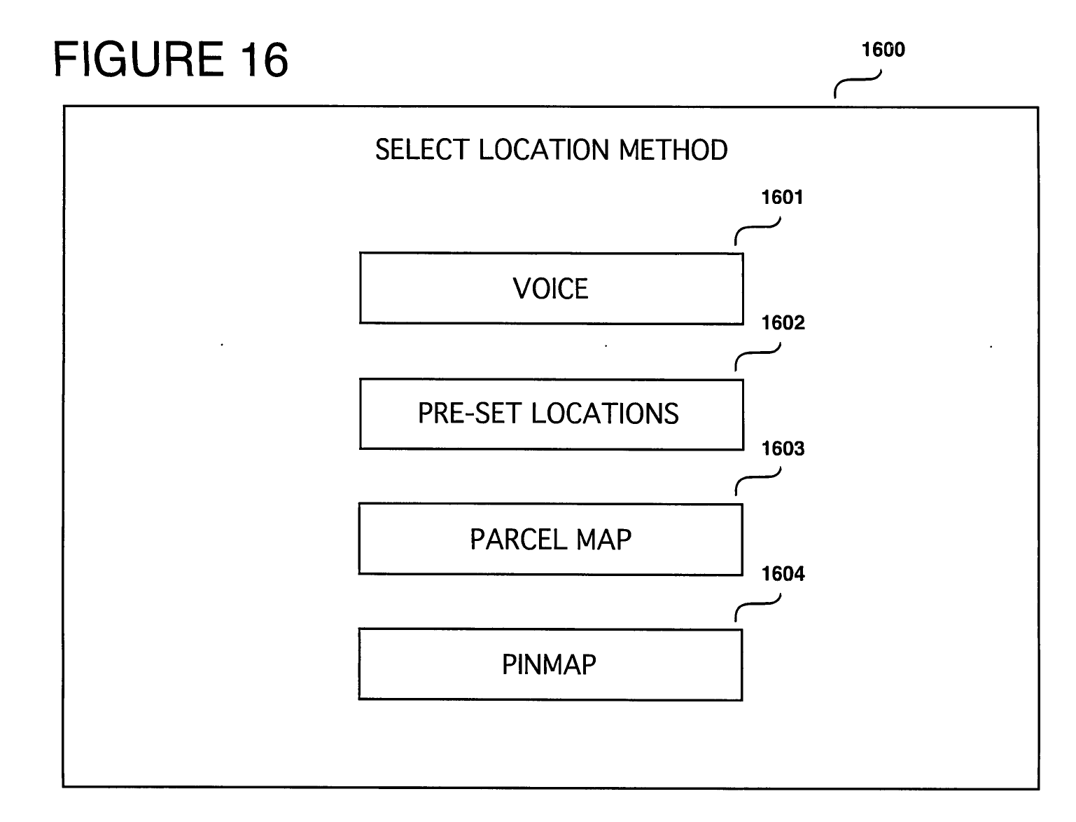

FIG. 16 is an illustration showing the graphical user interface utilized by present disclosure operators to select UAV deployment options using map based or pre-determined flight destinations 1600. Selection 1601 allows the user to utilize speech recognition software to input the street address of the desired flight destination. Selection 1602 allows the user to select from a list of pre-determined flight destinations that have been entered into the present disclosure's database. Selection 1603 allows the user to select a flight destination using parcel map boundaries, and selection 1604 allows the user to utilize an on-screen cursor to select a specific flight destination location using map interface.

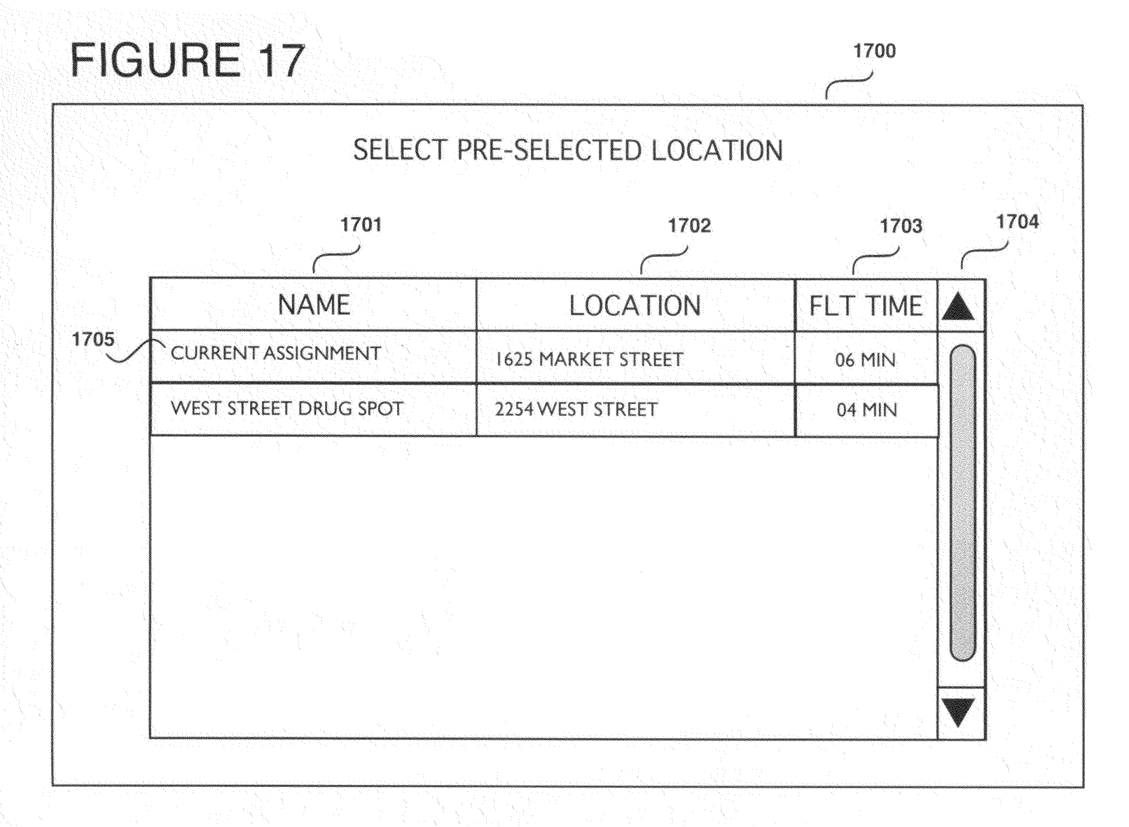

FIG. 17 is an illustration showing the graphical user interface utilized by present disclosure operators to select and deploy an integrated UAV to a pre-determined flight destination stored in the present disclosure's database 1700. The displayed location information can be organized into, but is not limited to the following subsets: name 1705 which can be assigned to a specific location, location 1702, which can be recorded using the location's street address or GPS coordinates, and the approximate flight time 1703 which is calculated by the present disclosure's computer processor by determining the flight distance between the UAVs pre-deployment location and the destination and the speed at which the UAV will travel while flying to the destination. An on-screen scrollbar 1704 can be used to view lists that extend beyond the viewing capacity of the computer display. If the user is assigned to a task using computer aided dispatch (CAD) software, the present disclosure can utilize this data to create a current assignment location 1705 that will allow an integrated UAV to be deployed and travel to a destination in advance of the vehicle from which it was deployed. For the purpose of this example, current assignment location shall be defined as a geographic location a person has been assigned to travel to for the purpose of completing a task.

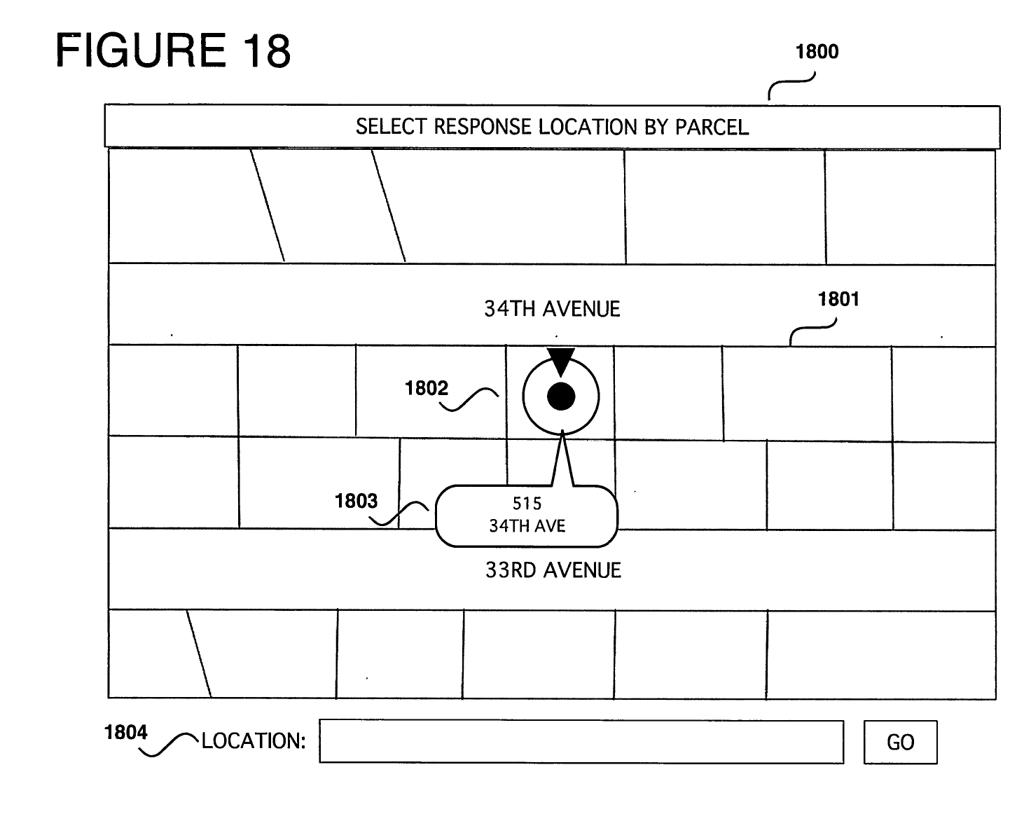

FIG. 18 is an illustration showing the graphical user interface utilized by present disclosure operators to deploy an integrated UAV to a destination by selecting the defined area of a map integrated with parcel line boundaries 1800. For the purpose of this patent application, a parcel shall be defined as an area of land or water that has defined boundaries tied to GPS measurements 1801. The present disclosure's user interface allows users to place a cursor 1802 within the boundaries of a parcel to select an integrated UAVs flight destination. The cursor's placement within the boundaries of a selected parcel will cause the user interface to display the street address or GPS coordinates of the location 1803. The user interface also allows navigation to a parcel by entering the specific street address associated with the parcel 1804.

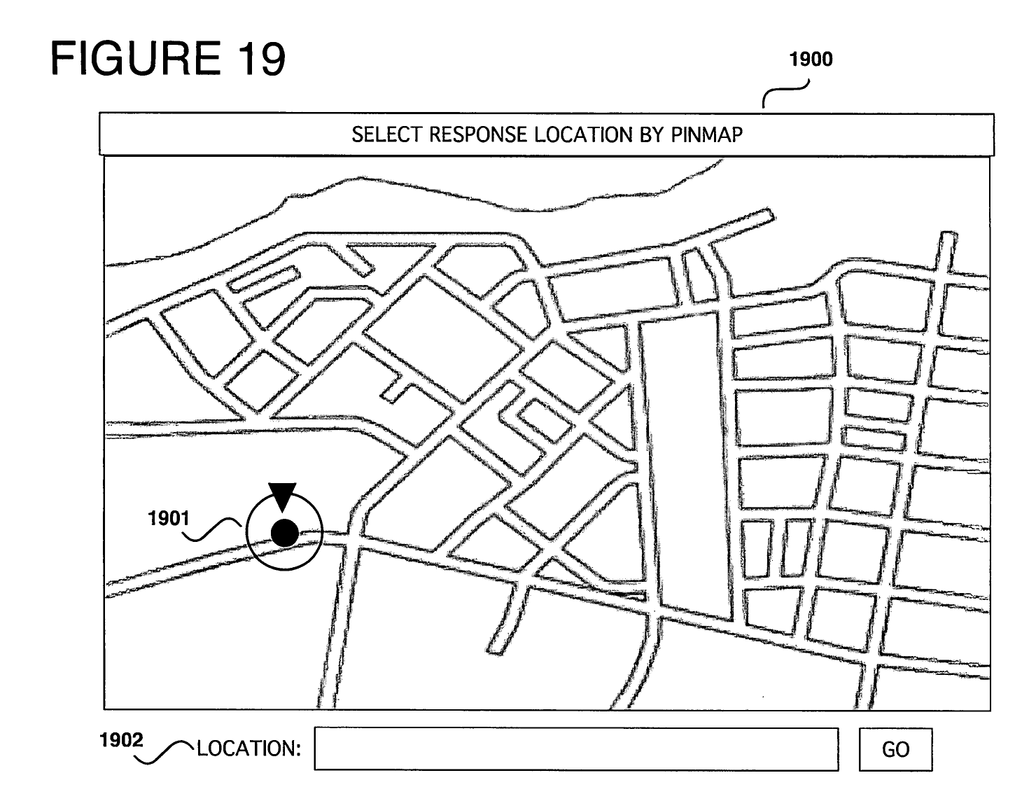

FIG. 19 is an illustration showing the graphical user interface utilized by present disclosure operators to deploy an integrated UAV to a selected location using cursor placement 1900. The present disclosure's user interface allows users to place a cursor 1901 over a specific location on a map. The location on the map where the cursor is placed is correlated with GPS coordinates allowing an integrated UAV to be deployed to the location. The user interface also allows navigation to a parcel by entering the specific street address associated with the parcel 1902.

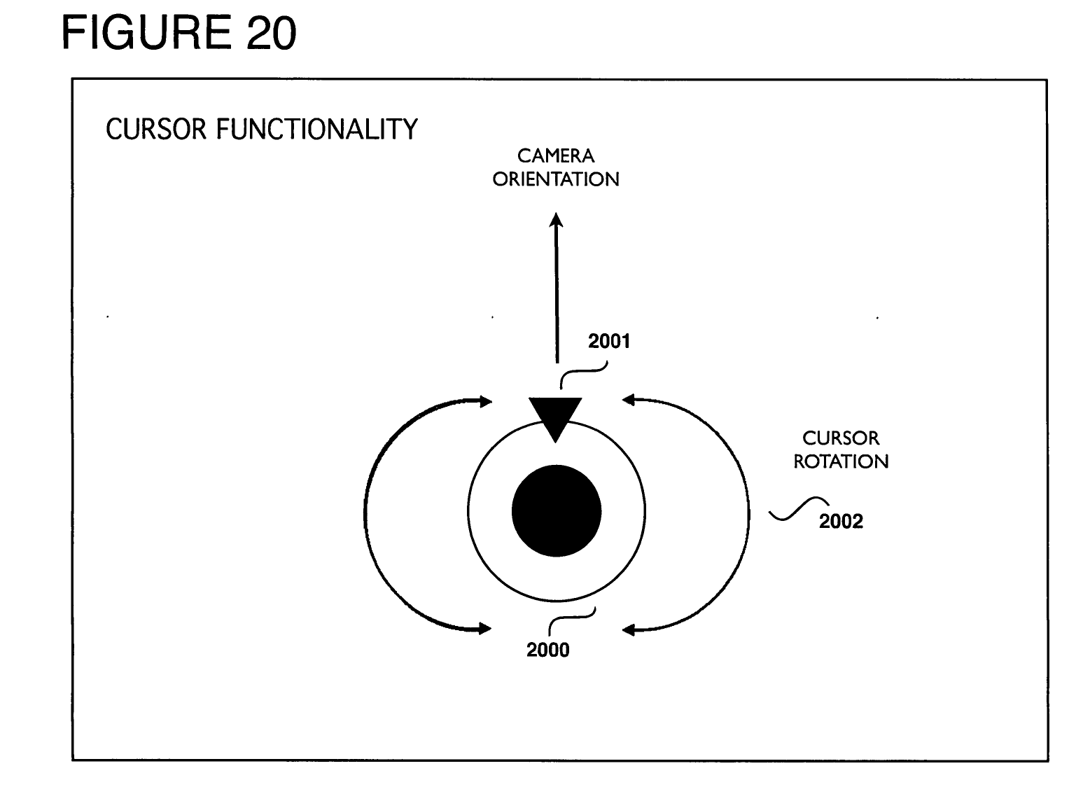

FIG. 20 is an illustration showing the cursor design 2000 of the graphical user interface utilized to deploy an integrated UAV to a selected location and to determine camera orientation upon arrival at the location. The cursor includes a camera direction indicator 2001 that can be rotated in either direction 2002 to orient an integrated UAVs camera system in a specific direction upon arrival at a location. The user interface screens shown in FIGS. 18 and 19 utilize this cursor.

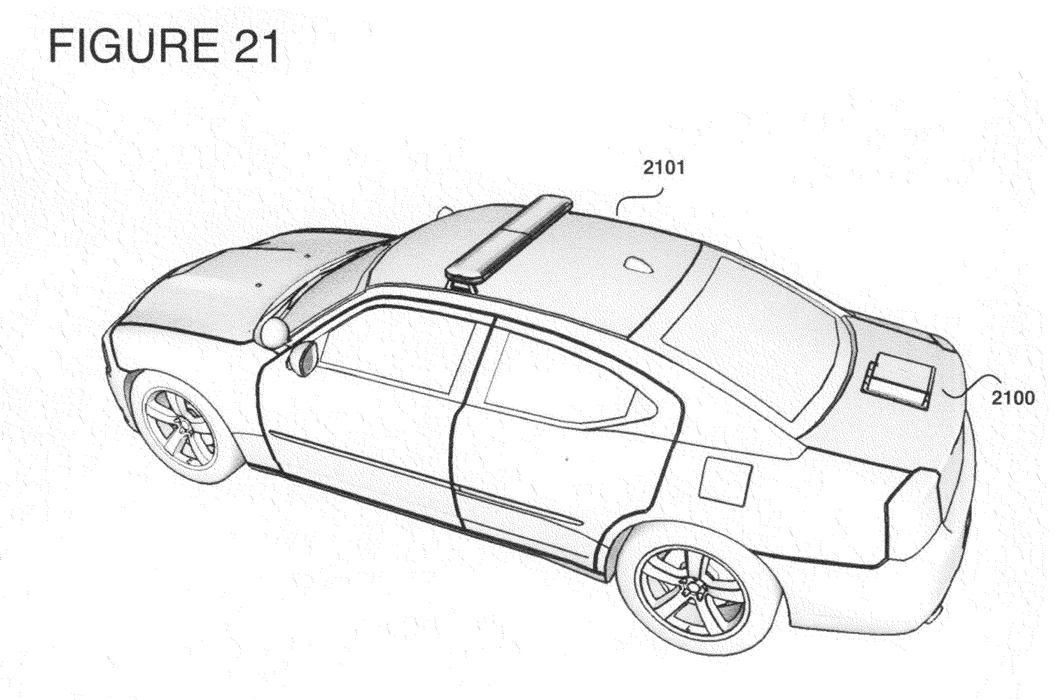

FIG. 21 is an illustration showing one of the present disclosure's UAV containers 2100 installed on the trunk area of a police vehicle 2101. The types of vehicles on which the present disclosure's UAV deployment system may installed include, but are not limited to: police and law enforcement vehicles, vehicles designed for firefighting, military vehicles, emergency response vehicles, watercraft, off-road vehicles, and other aircraft.

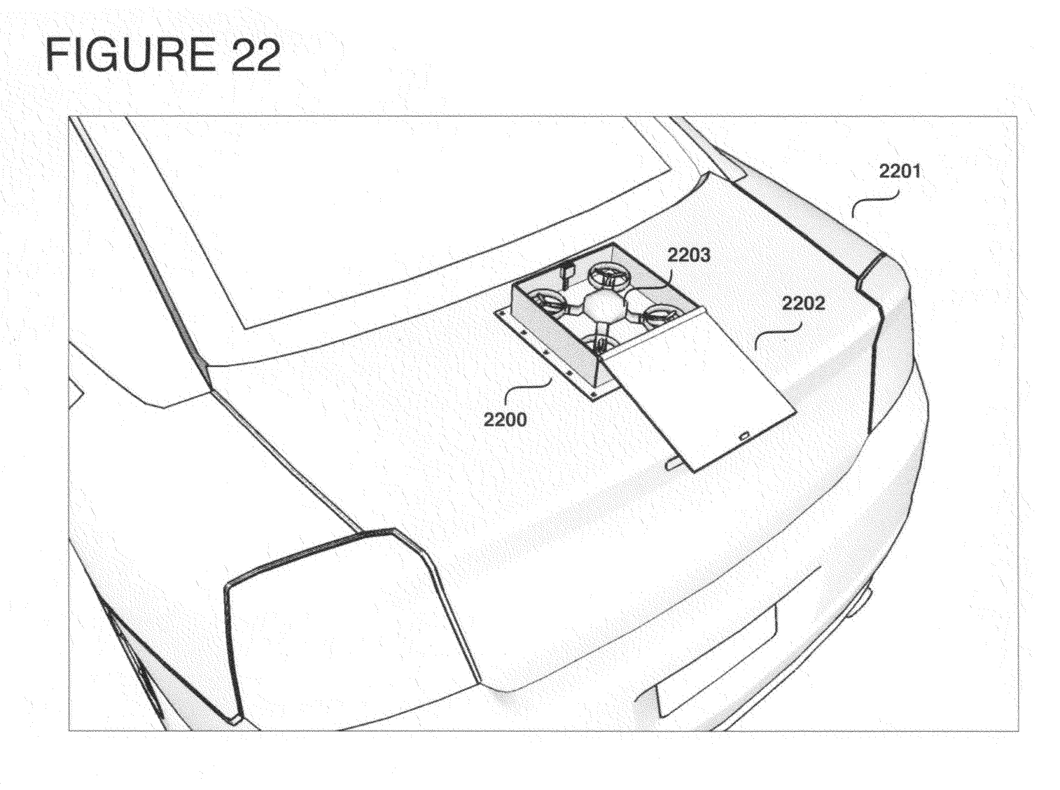

FIG. 22 is an illustration showing one of the present disclosure's UAV containers 2200 installed on the trunk area of a vehicle 2201 that has been opened 2202 to allow the deployment of an integrated UAV 2300.

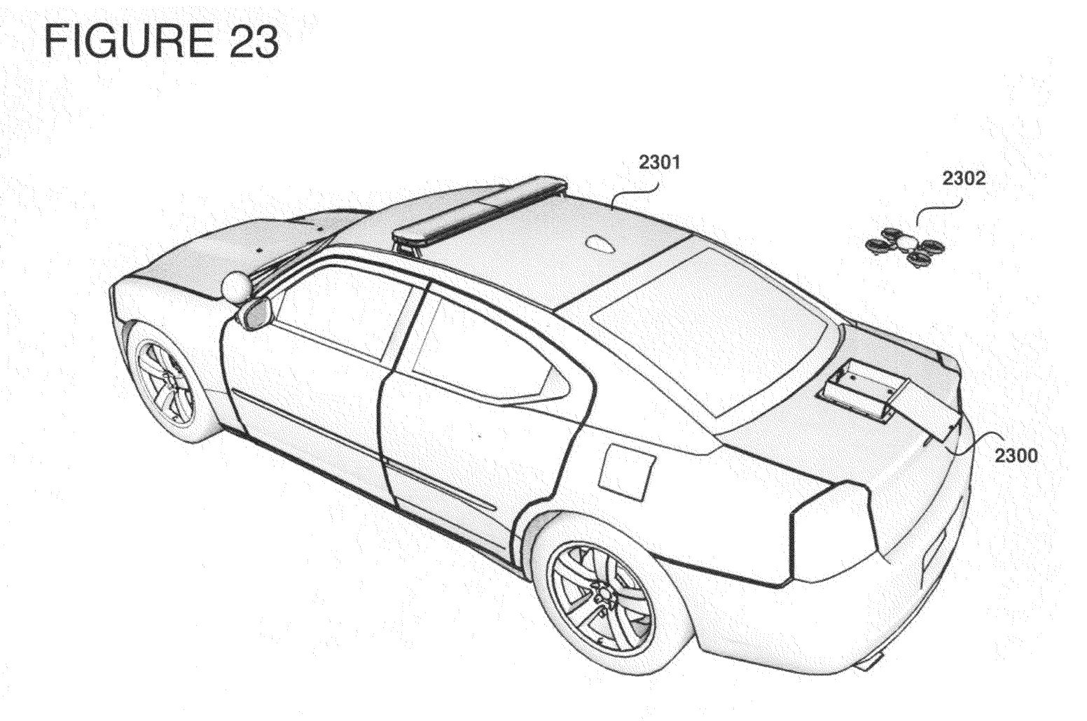

FIG. 23 is an illustration showing one of the present disclosure's open UAV containers 2300 installed on the trunk area of a vehicle 2301. The integrated UAV 2302, has been deployed and is beginning to fly in an upward direction. The present disclosure's UAV containers can be configured to enable the installation of the present disclosure on any portion of a vehicle that will allow an integrated UAV to be deployed. The flight direction, upon initial deployment in relation to the vehicle carrying the UAV, can be performed in any direction (the most practical launch direction to accomplish a successful deployment in relation to the vehicle's performance characteristics and components).

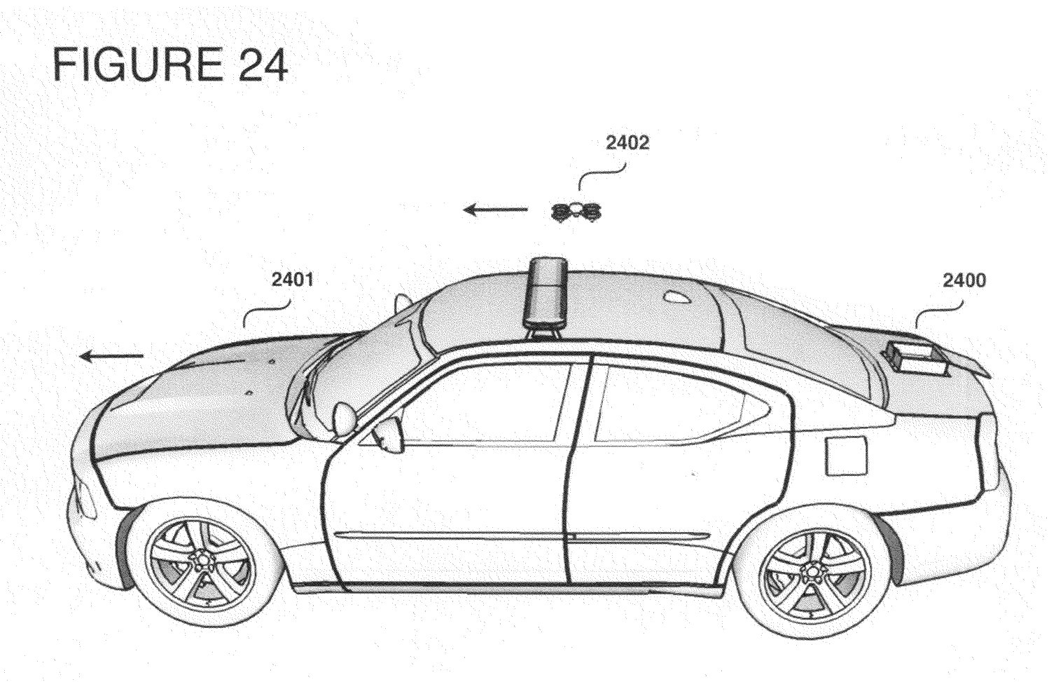

FIG. 24 is an illustration showing one of the present disclosure's open UAV containers 2400 installed on the trunk area of a vehicle. The integrated UAV 2400, in this example, has been deployed and is following the moving vehicle 2401 from which it was launched. The methods used by the present disclosure to enable an integrated UAV to follow the vehicle from which it was deployed can include, but are not limited to the following: optical tracking, GPS synchronization, real-time kinematic GPS (RTK), and wireless communication transmissions.

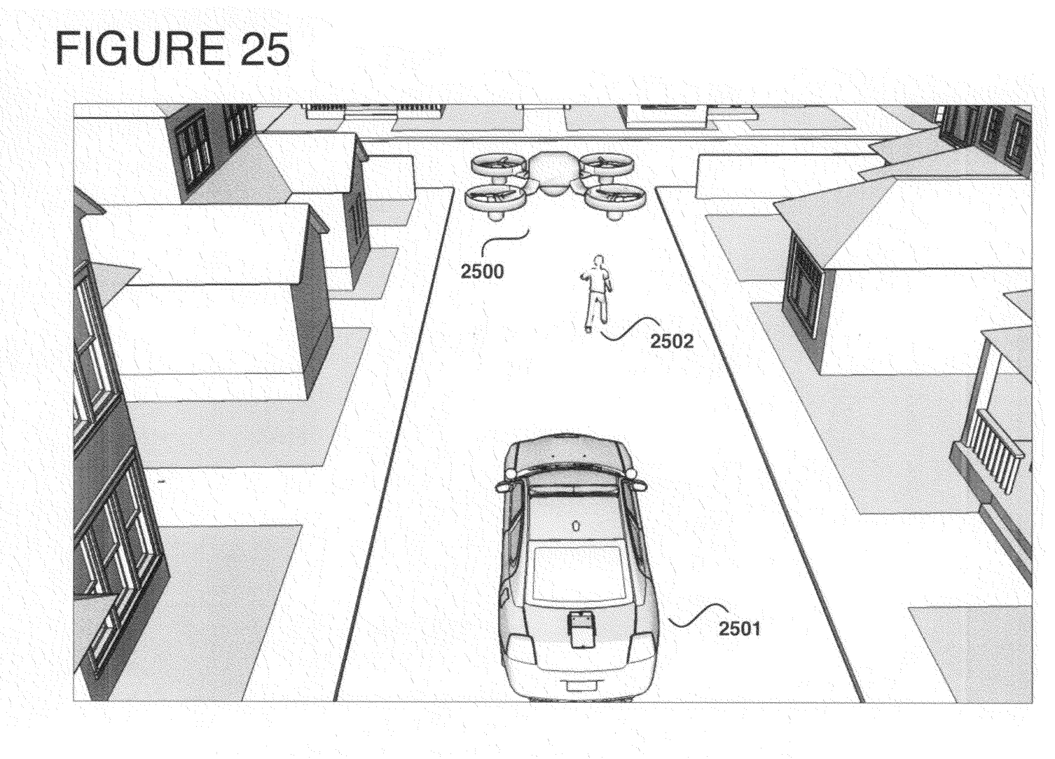

FIG. 25 is an illustration showing a neighborhood where one of the present disclosure's integrated UAVs 2500 has been deployed from a vehicle 2501 and is being controlled (either locally or remotely) to follow a fleeing person 2502.

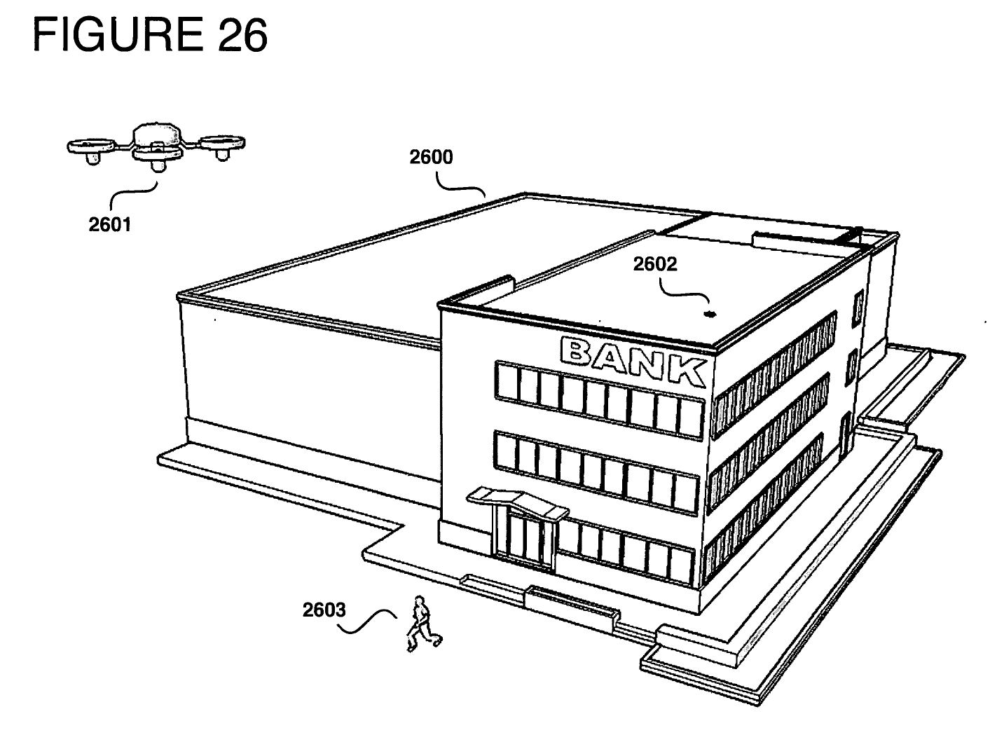

FIG. 26 is an illustration showing a commercial building 2600 one of the present disclosure's integrated UAVs 2601 has been deployed from a rooftop container 2602. The UAV is being controlled (locally or remotely) to follow a fleeing person. A use case example of this use of the present disclosure would be the following: The bank has one of the present disclosure's integrated UAV deployment systems installed on the roof. The system is configured to deploy the UAV when an employee determines that a robbery is occurring inside the bank and triggers a covert alarm. Upon doing so, the UAV is deployed and immediately flies (pursuant to a pre-programmed flight path) to a fixed position and hovers in place allowing its onboard camera system to provide a view of the bank's entrance/exit. The present disclosure simultaneously sends an alert signal to an integrated monitoring center where an operator accepts control of the UAV and begins to actively monitor the UAVs camera system. The operator observes a person fleeing from the bank and begins to follow the person using the piloted UAV. The operator is able to follow and update responding law enforcement officers with the location of the fleeing person who is taken into custody by police.

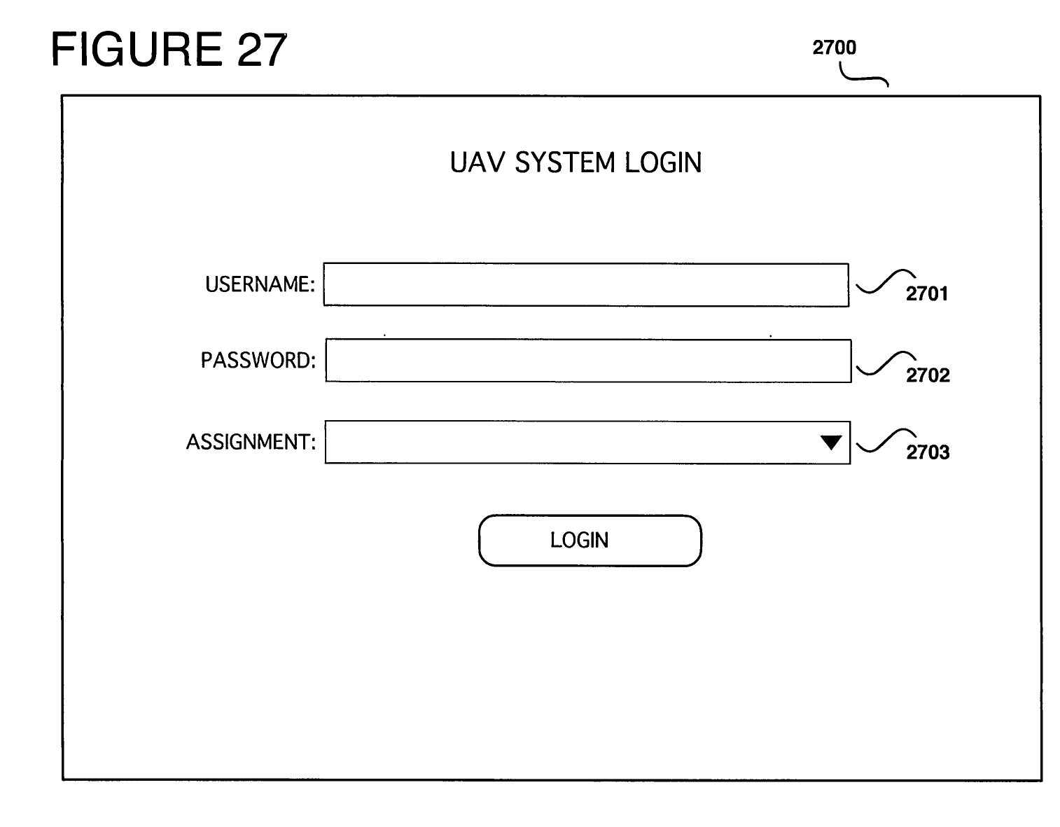

FIG. 27 is an illustration showing the graphical user interface 2700 utilized by present disclosure operators to access the present disclosure's components and functions and prevent unauthorized persons from accessing the present disclosure. The present disclosure's login screen requires the following data for system authentication: username 2701, password 2702, and assignment 2703. The present disclosure can be configured to require additional data for login authentication to include the use of biometric information depending on end user requirements.

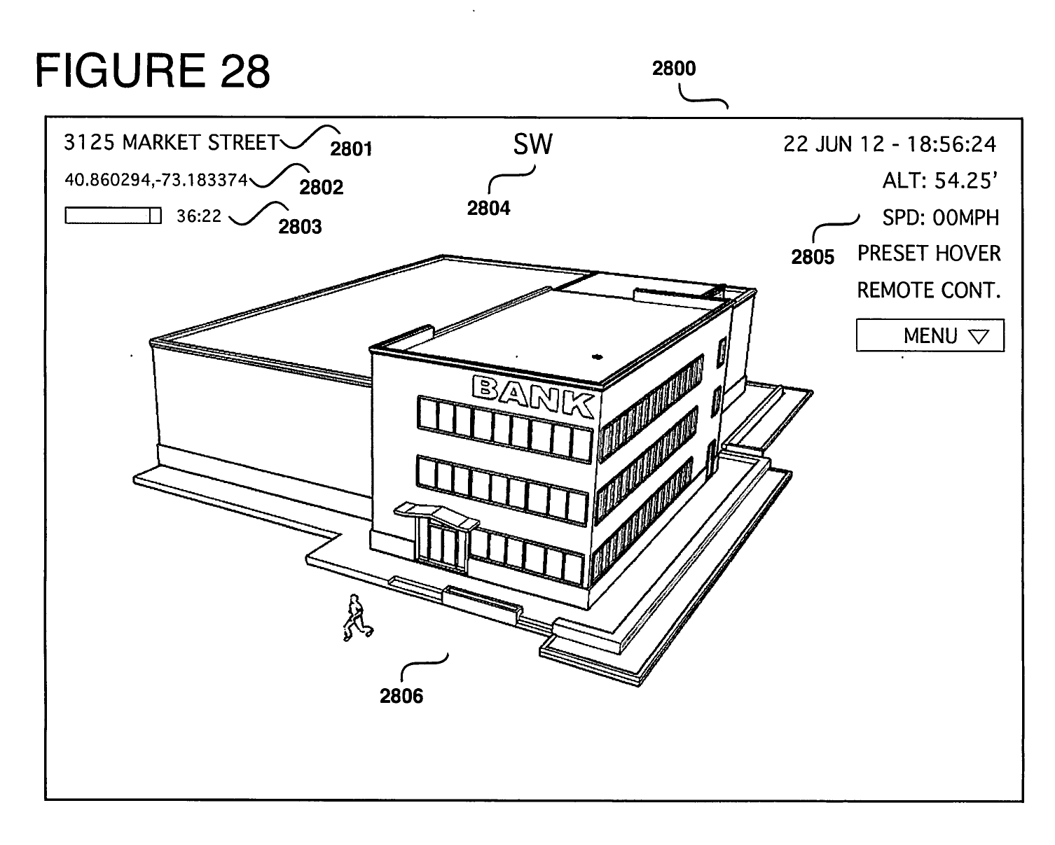

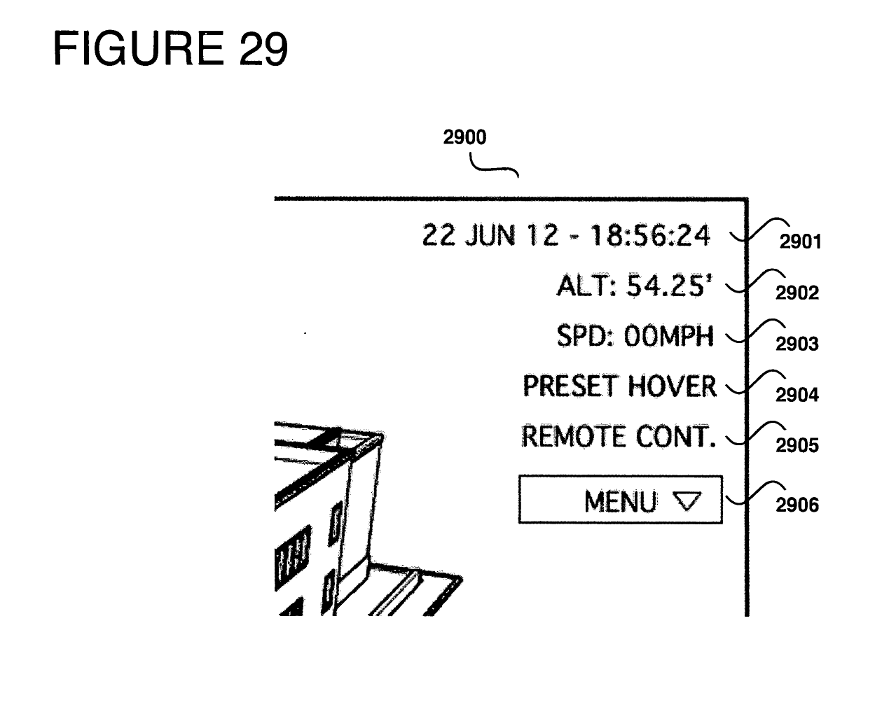

FIG. 28 is an illustration showing the graphical user interface utilized by operators of the present disclosure to view an integrated UAV camera display and monitor data associated with an integrated UAV deployment 2800. The display can include but is not limited to closest street address to the deployed UAV 2801 (determined utilizing parcel map data) GPS location data 2802, remaining battery or power supply information 2803, the direction in which the deployed UAVs onboard camera is oriented 2804, additional deployment data 2805 (detailed in FIG. 29) and the UAVs camera display 2806.

FIG. 29 is an illustration showing additional deployment data and functionality comprising the graphical user interface utilized by operators of the present disclosure to view an integrated UAV camera display and monitor data associated with an integrated UAV deployment 2900. The display can include but is not limited to the current date and time 2901, the current altitude of the deployed UAV 2902, the current airspeed of the deployed UAV 2903, the current type of flight maneuver being performed 2904 (FIG. 13, 1300-1305) and the flight control status 2905 (local or remote). An additional drop-down menu can be accessed to perform additional control functions 2906.

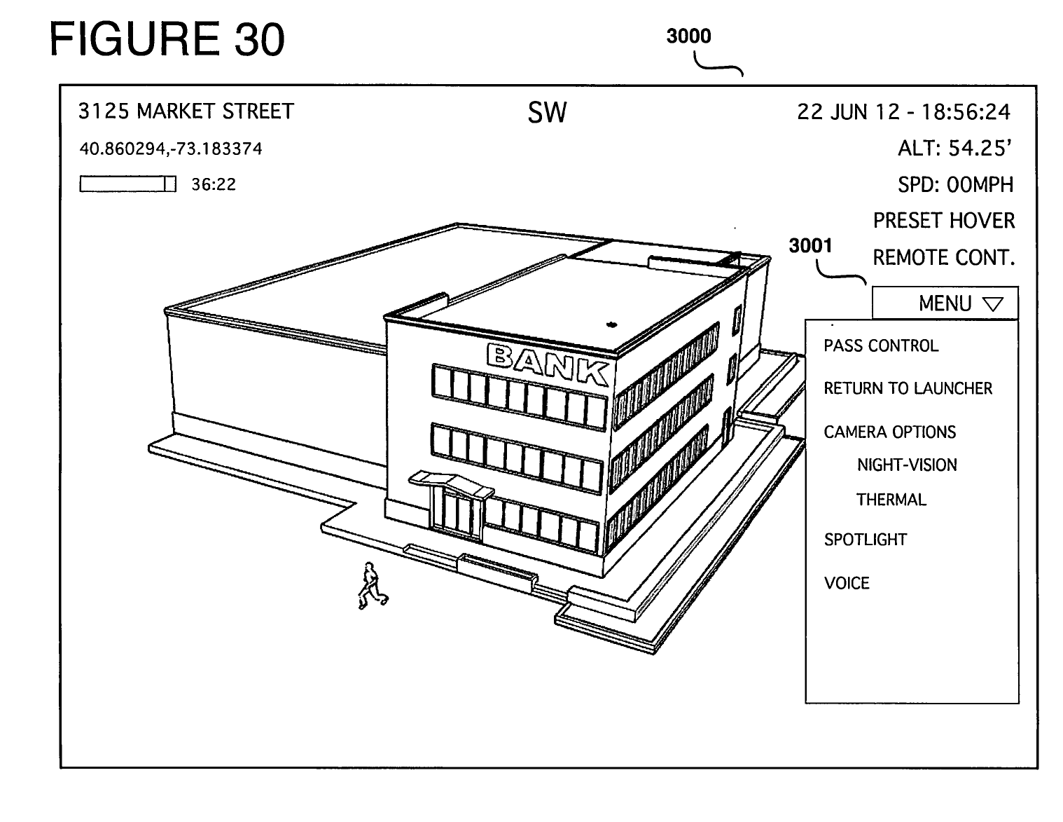

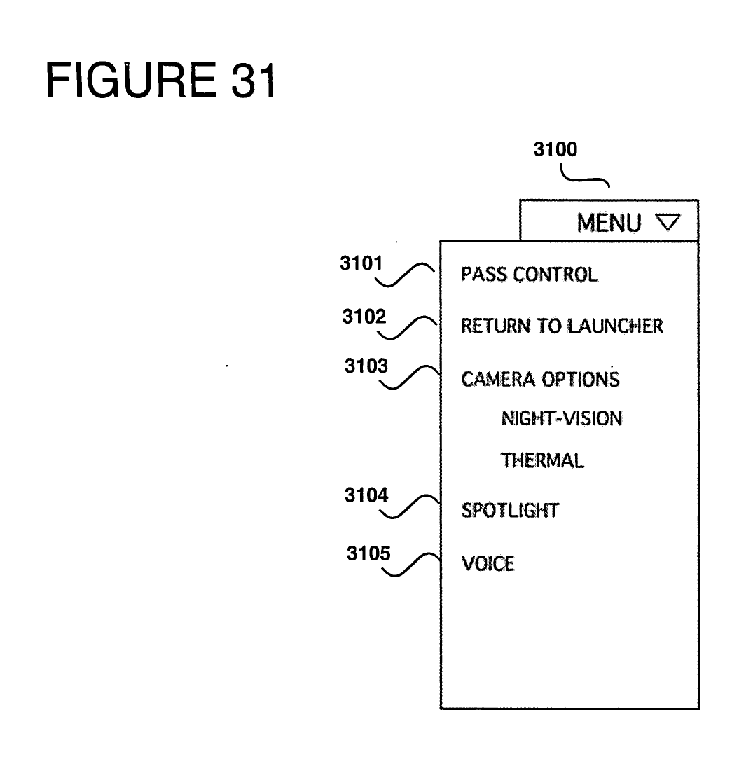

FIG. 30 is an illustration showing the dropdown menu option 3000 of the graphical user interface to monitor data associated with an integrated UAV deployment and perform additional integrated UAV control functions 3001 (detailed in FIG. 31).

FIG. 31 is an illustration showing the dropdown menu option of the graphical user interface with examples of integrated UAV control functions 3100. The dropdown menu can allow users to perform, but is not limited to additional control functions such as the ability to pass flight control of a deployed UAV to another user with connectivity to the same UAV 3101, the ability to direct the deployed UAV to the container from which it was launched 3102, the ability to change camera views or camera types if the UAV is equipped with multiple cameras 3103, the ability to turn a spotlight on/off (if equipped) 3104, and the ability to transmit audio/voice (if equipped) 3105. Additional functions that can be controlled from this user interface include but are not limited to radiological readings/detection, chemical or biological readings/detection.

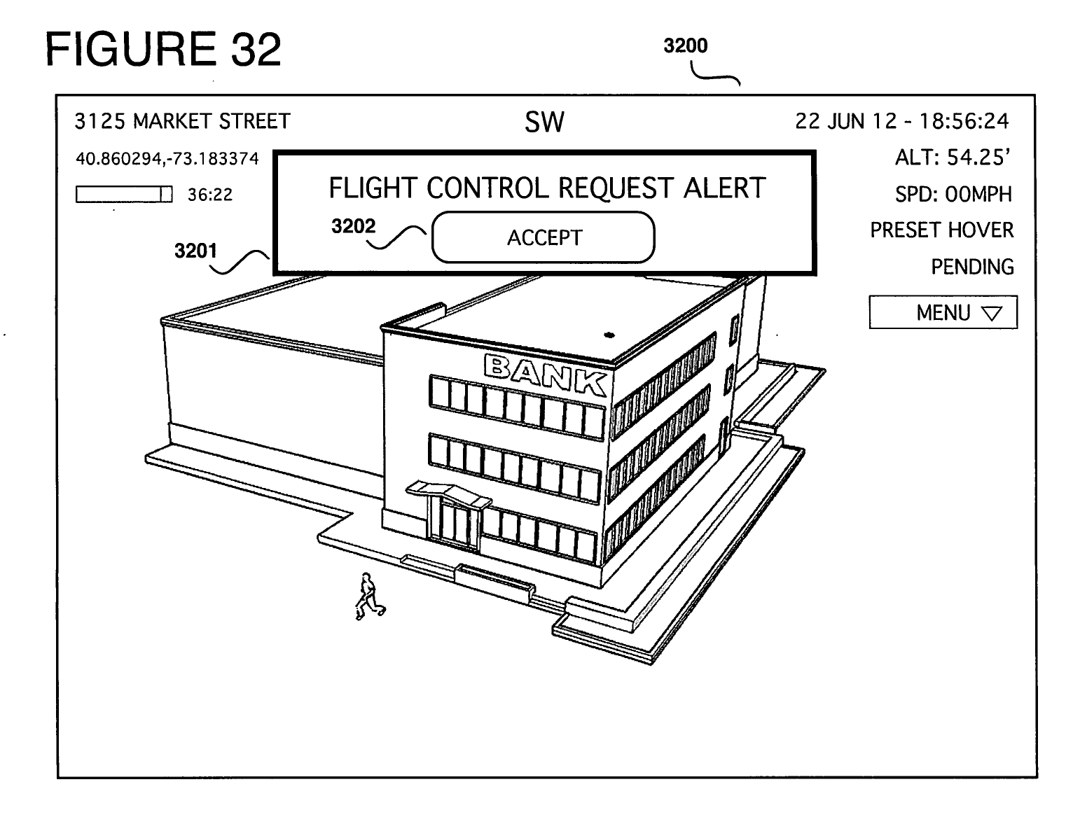

FIG. 32 is an illustration showing an alert displayed by the graphical user interface to notify present disclosure operators that an integrated UAV has been deployed and that they are being requested to assume remote control of the UAVs flight control functions 3200. The alert screen displays current flight data and camera views from the deployed UAV 3200 (data provided in FIGS. 27 and 28) and a notification requesting that the recipient assume control of the deployed UAV 3201. Utilization of the accept button 3202 allows the user to take over the flight controls and equipped functions of the deployed UAV.

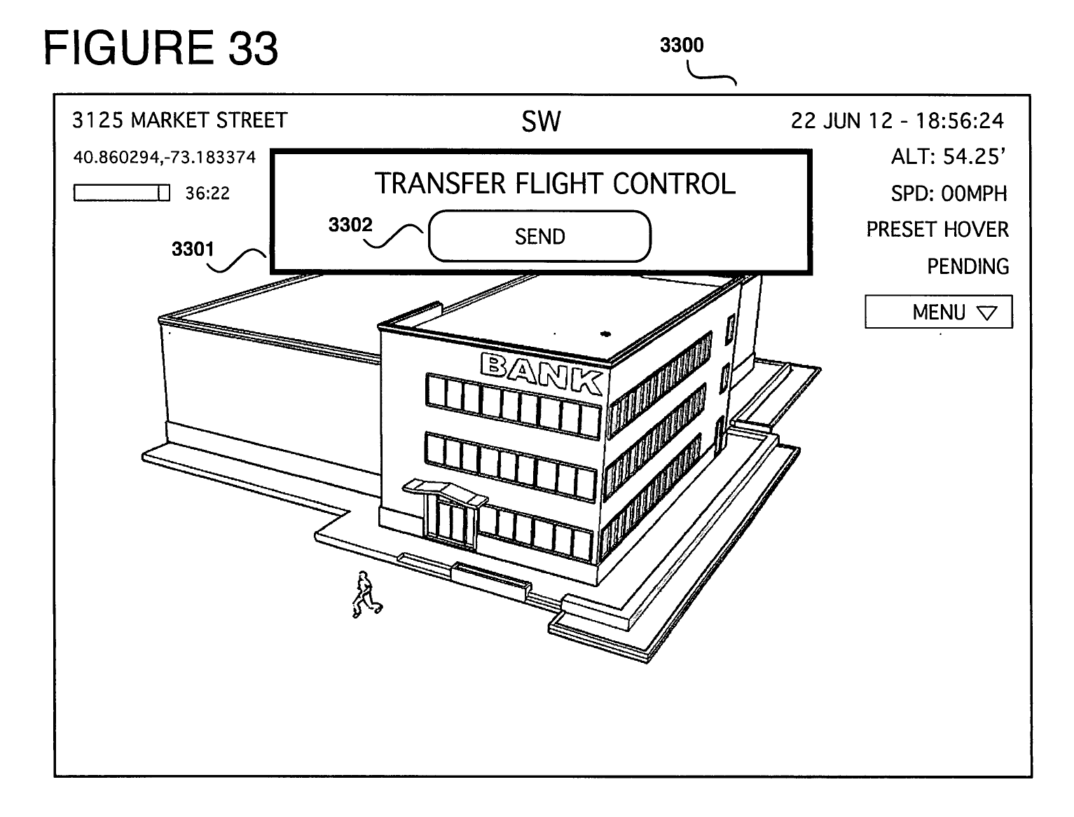

FIG. 33 is an illustration showing a prompt displayed by the graphical user interface confirming that an present disclosure operator desires to transfer the flight control functions to another present disclosure operator. The screen continues to display current flight data and camera views from the deployed UAV 3300 (data provided in FIGS. 27 and 28) and a prompt notification is displayed to confirm the current operator desires to relinquish control of the deployed UAV 3301. Utilization of the send button 3202 allows the user to remain in control of the UAV and equipped functions until the recipient operator assumes the UAVs flight controls.

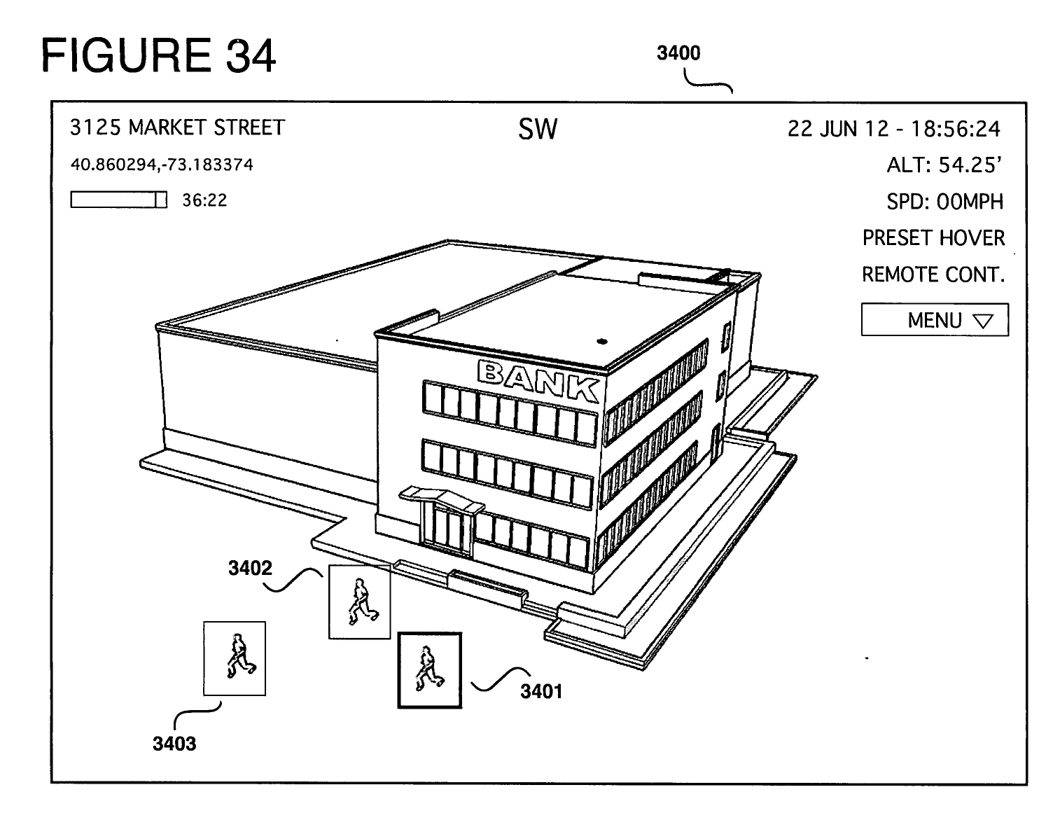

FIG. 34 is an illustration showing the graphical user used to view an integrated UAVs camera display and to a person or vehicle to be automatically followed by a deployed UAV. The present disclosures user interface 3400 can be integrated to utilize optical tracking technology to allow an integrated and deployed UAV to automatically follow a selected target. In this example, the optical tracking utilized by the present disclosure has identified three persons moving away from the bank 3401, 3402, and 3403. The user interface has displayed rectangular outlines over the identified persons and the user has selected a specific person 3401 for the UAV to automatically follow. The user interface indicates that the person 3401 has been selected by turning the rectangular outline a different color and the outline has grown noticeably thicker. The deployed UAV will continue to automatically follow (autopilot) the selected person until the UAV is removed from auto-follow mode and controlled manually.

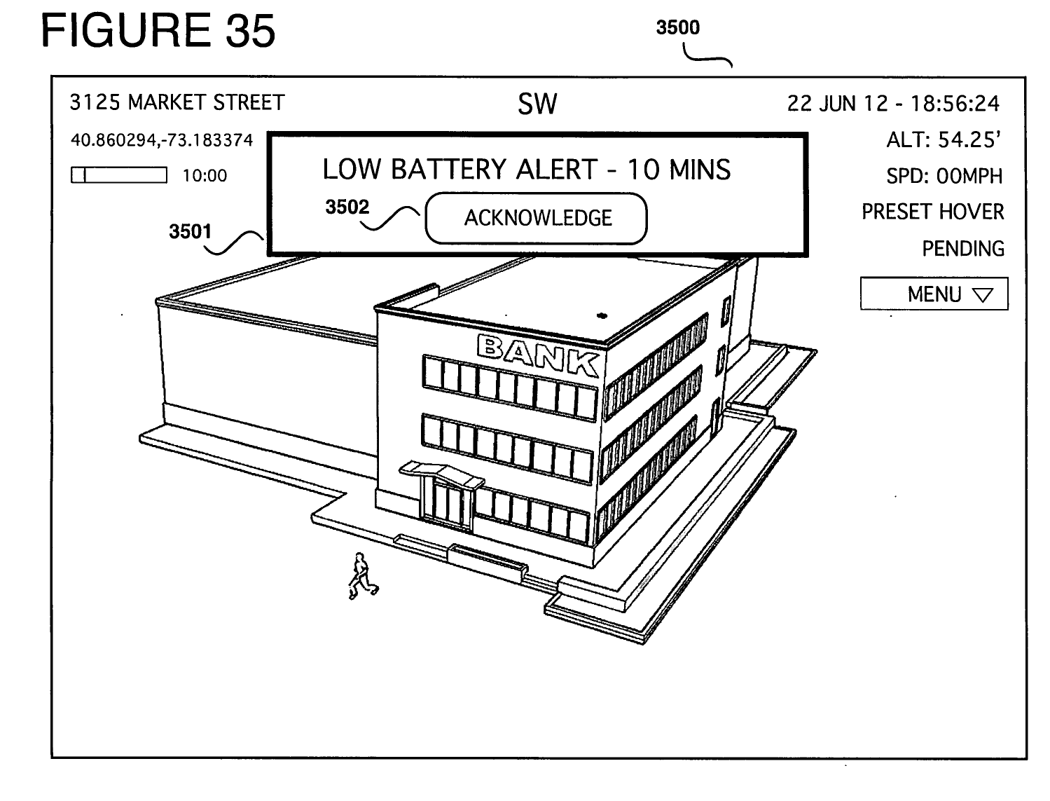

FIG. 35 is an illustration showing an alert displayed by the graphical user interface to notify present disclosure operators that the battery providing power to a deployed UAV has reached a predetermined power providing capacity. The screen continues to display current flight data and camera views from the deployed UAV 3500 (data provided in FIGS. 27 and 28) and an alert notification is displayed to inform the current operator and any additional persons using the present disclosures user interface to monitor the UAV that the power supply is low and the estimated remaining power supply time is displayed 3501. The current operator can dismiss the alert by pressing the acknowledge button 3502. The present disclosure can be configured to issue additional alerts at any desired power supply levels.

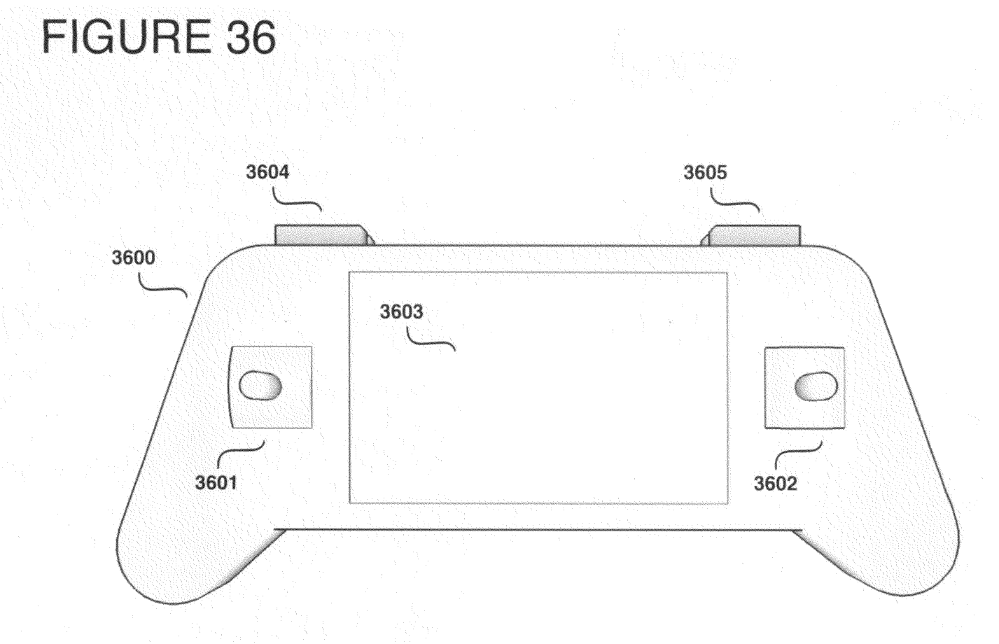

FIG. 36 is an illustration example of an integrated handheld controller 3600 that can be used by present disclosure users to control the flight functions of an integrated and deployed UAV. Comprising the controller are, but not limited to the following functional elements: joysticks or similar acting control mechanisms 3601, 3602 that can be utilized to control an integrated UAVs yaw, throttle, pitch and roll. A touch-screen video display 3603 allows the ability to view the present disclosure's graphical user interface (including, but not limited to FIG. 28). Additional command buttons 3604, 3605 and be configured to perform additional UAV control functions.

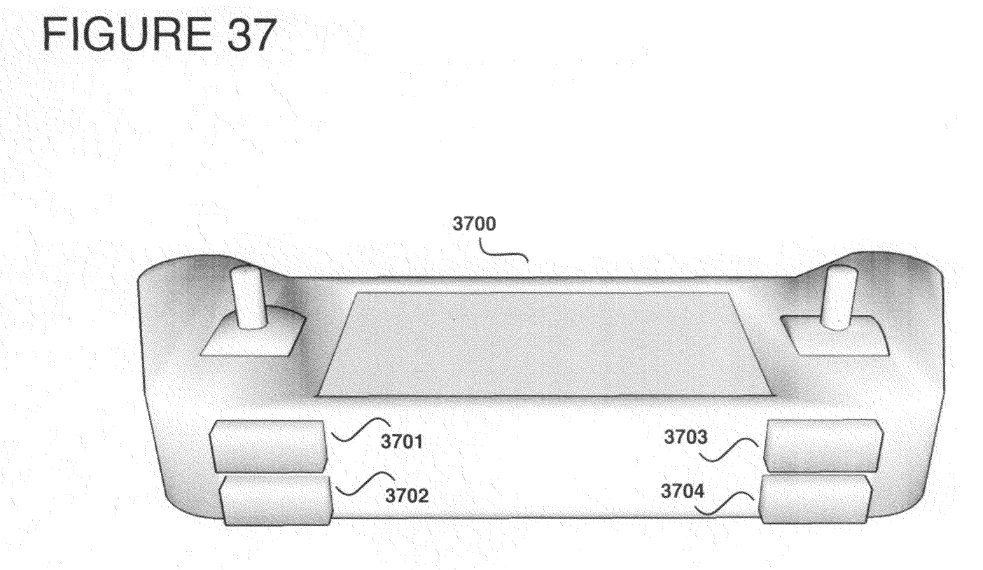

FIG. 37 is an illustration example of an integrated handheld controller 3700 with additional command buttons 3701, 3702, 3703, and 3704 that can be used by present disclosure users to control the flight functions of an integrated and deployed UAV. Four buttons are used in this example but additional buttons can be configured to function with the present disclosure. Examples of additional control functions can include but are not limited to: camera pan, tilt, and zoom functions, spotlight on/off switches, and commands such as directing the UAV to stop and hover in place.

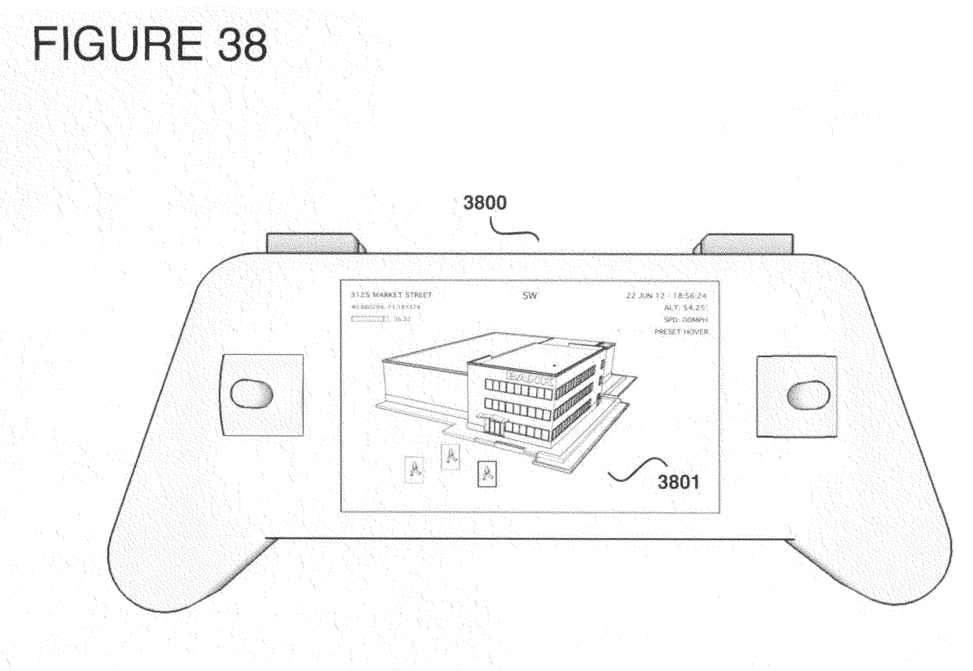

FIG. 38 is an illustration example of an integrated handheld controller 3800, with an integrated, touch-screen video display capable of displaying the graphical user interface 3801, utilized by present disclosure operators to view the camera display and data associated with an integrated UAV deployment.

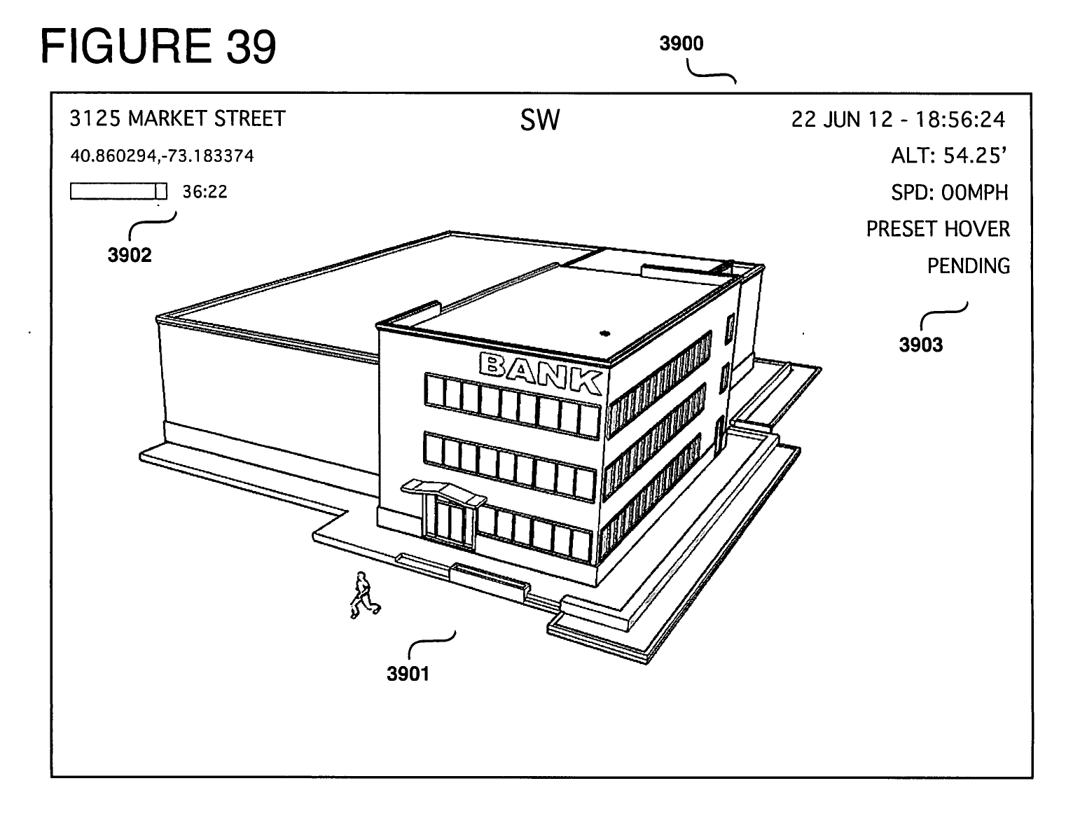

FIG. 39 is an illustration of the graphical user interface used by personnel with access to the present disclosure to view, but not control, the flight functions, camera display, and data associated with an integrated UAV deployment 3900. Persons who are granted access to the present disclosure using the login authentication screen (FIG. 27) can be authorized to view the camera display 3901 and associated data 3902 and 3903 related to an active UAV deployment.

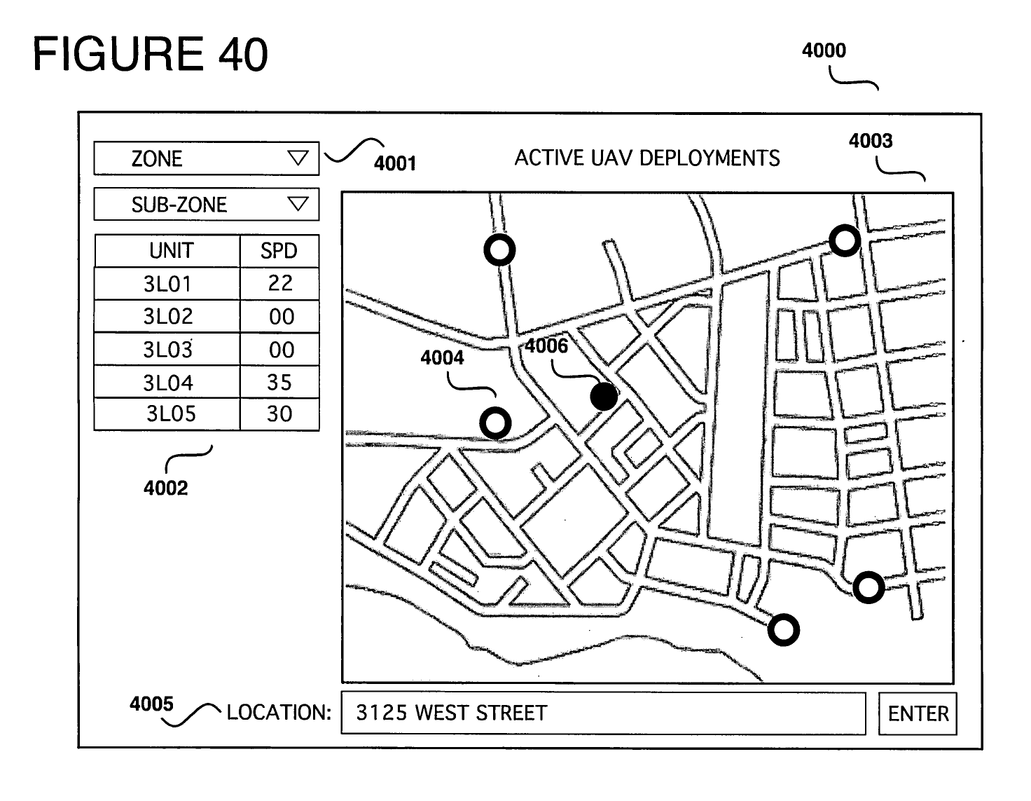

Times may occur where there is a need to deploy an integrated UAV from a vehicle or building where a local operator (person with physical control of the UAV) is unable to initiate the deployment. FIG. 40 is an illustration of the graphical user interface used by personnel to monitor the relative positions and status of integrated UAV systems installed on vehicles or at fixed locations such as building rooftops 4000. The user interface consists of, but is not limited to the following elements: drop down menu options 4001 that allow a user to quickly navigate to a geographic area or zone, a list 4002 of integrated UAVs available for deployment, and the speed the vehicle carrying the UAV (if applicable) is travelling. The interface contains a map of the area 4003, which displays UAVs available for deployment are located along with their relative positions 4004. A specific address can be manually entered 4005, or imported from a data source such as a computer aided dispatch system (CAD), resulting in the location being displayed graphically on the map interface 4006 as well.

A use case example of this use of the present disclosure (FIG. 40) would be the following: A remote operator of the present disclosure is monitoring police radio traffic and is notified that a shooting has just taken place at a location within a geographic zone where UAVs available for deployment are located. The operator imports the location 4005 from an integrated CAD system and utilizes the present disclosure's user interface 4000 to determine which UAVs 4002 are available and closest to the shooting incident 4006. The operator determines that unit “3L05” 4004, is closest UAV available for deployment and response to the shooting scene. The driver and local UAV pilot of unit “3L05” is unable to launch the UAV because he/she is handling an unrelated incident and is away from his/her vehicle. The remote operator utilizes the present disclosure to remotely deploy the UAV from vehicle “3L05” and takes flight control piloting the UAV to the location of the shooting.

A second use case example of this use of the present disclosure (FIG. 40) would be the following: An officer has conducted a traffic enforcement stop using a vehicle equipped with a deployable UAV. During the incident, and while on foot dealing with the driver of the suspect vehicle, the suspect exits the vehicle and begins fighting with the officer in the street. The suspect runs away and the officer pursues the suspect on foot. A remote operator monitoring the incident determines that the officer's vehicle is equipped with a deployable UAV and remotely launches it to maintain visual contact (using the UAVs camera system) of the pursuing officer and relays information to officers responding to the scene for help.

A third use case example of the use of the present disclosure (FIG. 40) would be the following: A squad of military personnel have exited their transport vehicle to investigate a suspicious object detected in the roadway. While conducting the investigation, a sniper from an unknown location begins to shoot at the squad forcing them to seek cover from the incoming gunfire. A remote operator monitoring the incident determines that the squad's vehicle is equipped with a deployable UAV and remotely launches it to gain better visual access (using the UAVs camera system) to the location where the gunfire is believed to be coming from and relays the location of the sniper to personnel on the ground and additional responding personnel (whether in ground vehicles or piloted aircraft).

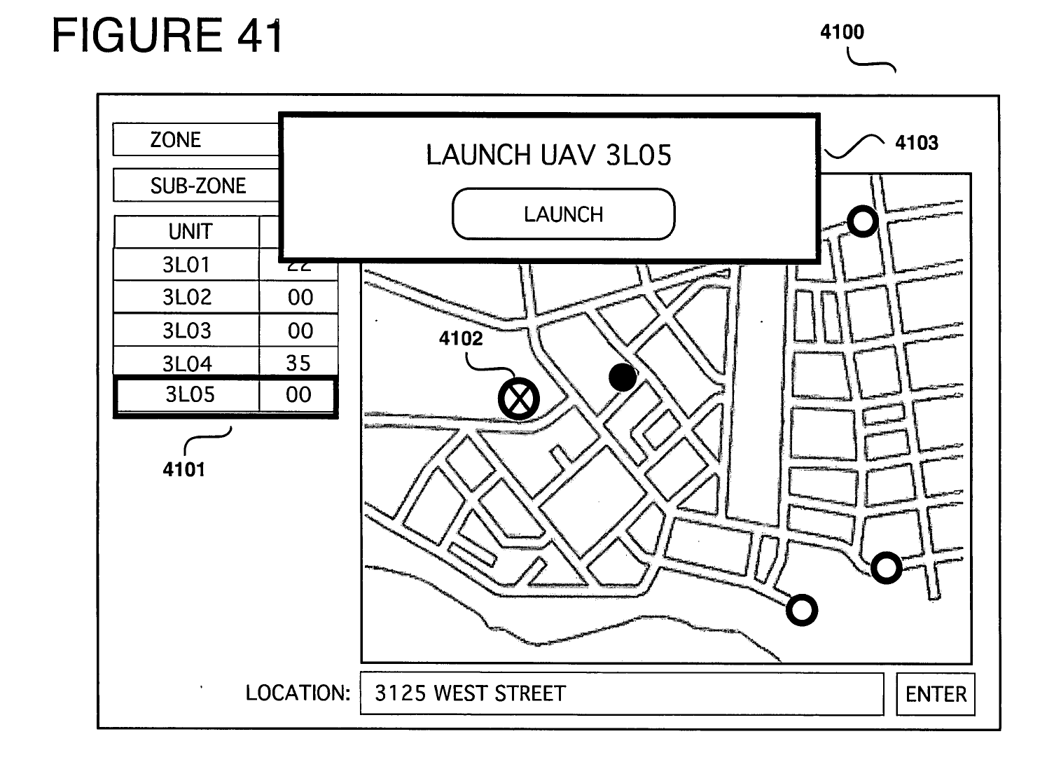

FIG. 41 is an illustration of the graphical user interface used by personnel to monitor the relative positions and status of integrated UAV systems installed on vehicles or at fixed locations such as building rooftops 4100. The user has selected an available UAV 4101 (list view) 4102 (map view) for flight deployment and a prompt is being displayed to confirm the launch 4103.

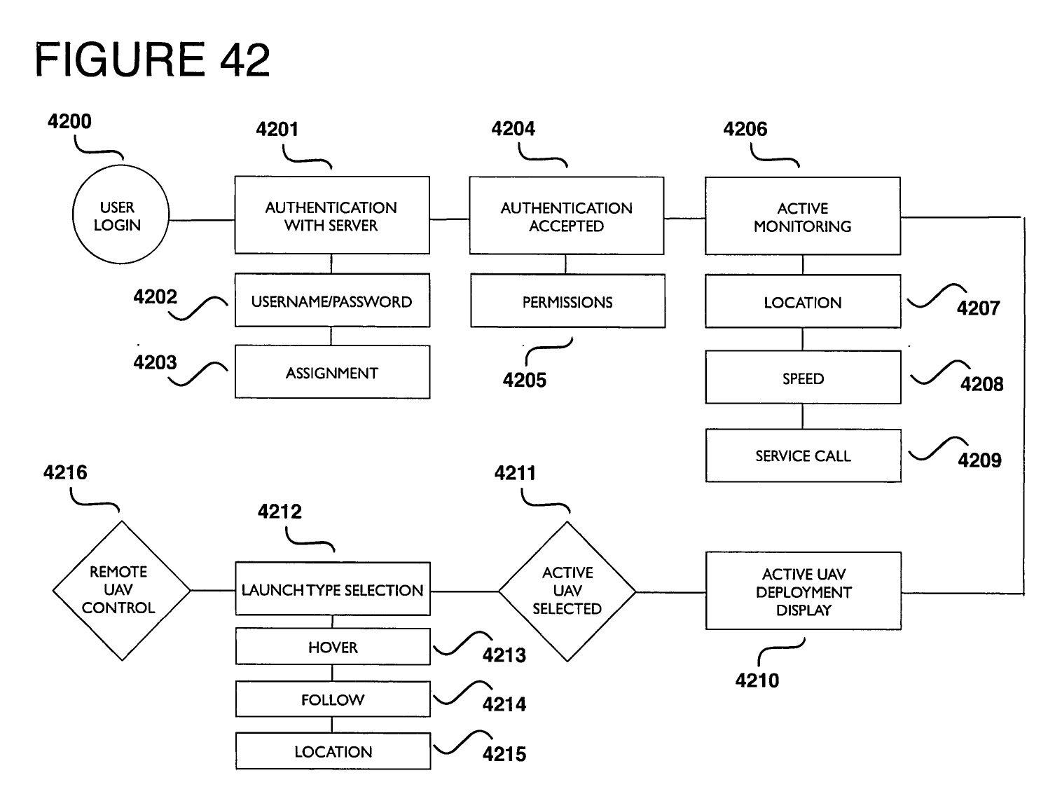

FIG. 42 is a flowchart illustration showing the present disclosure's functions and processes that allow a remote user to select and deploy an integrated UAV. The process begins when the present disclosure's login screen (FIG. 27) is used to authenticate 4200 a person who will be driving a vehicle equipped with a remote UAV or will stationed at a fixed location (building or other fixed object) equipped with an integrated AUV. The authentication process 4201 confirms with the present disclosures central computer server that the username, password, and assignment are authorized 4202, 4203, and successful authentication 4204 will enable user permissions granted to individual persons. For example, a person may be authorized to drive a vehicle equipped with a deployable UAV which can be launched and controlled by another remotely based operator but the person may not be authorized to control the UAV locally. Once the login/authentication process has been completed, the present disclosure actively monitors 4206 the location 4207, speed of the vehicle carrying the UAV 4208 (if applicable), and active service call assignments (4209) (if configured to do so). One or more remote present disclosure operators are able to monitor the status of UAVs available for deployment 4210 using the present disclosure's user interface (depicted in FIG. 40). Operators are able to select an available UAV for deployment 4211 and select the type of flight control response (launch) 4212, 4213, 4214, 4215, (also depicted in FIGS. 15 and 16). Once deployed, the remote operator controls the UAV 4216 until the deployment is determined to be complete or the operator relinquishes control to another operator. If the UAV is launched remotely from a vehicle, the present disclosure will utilize the evaluation process (depicted in FIG. 12) prior to deploying the UAV.

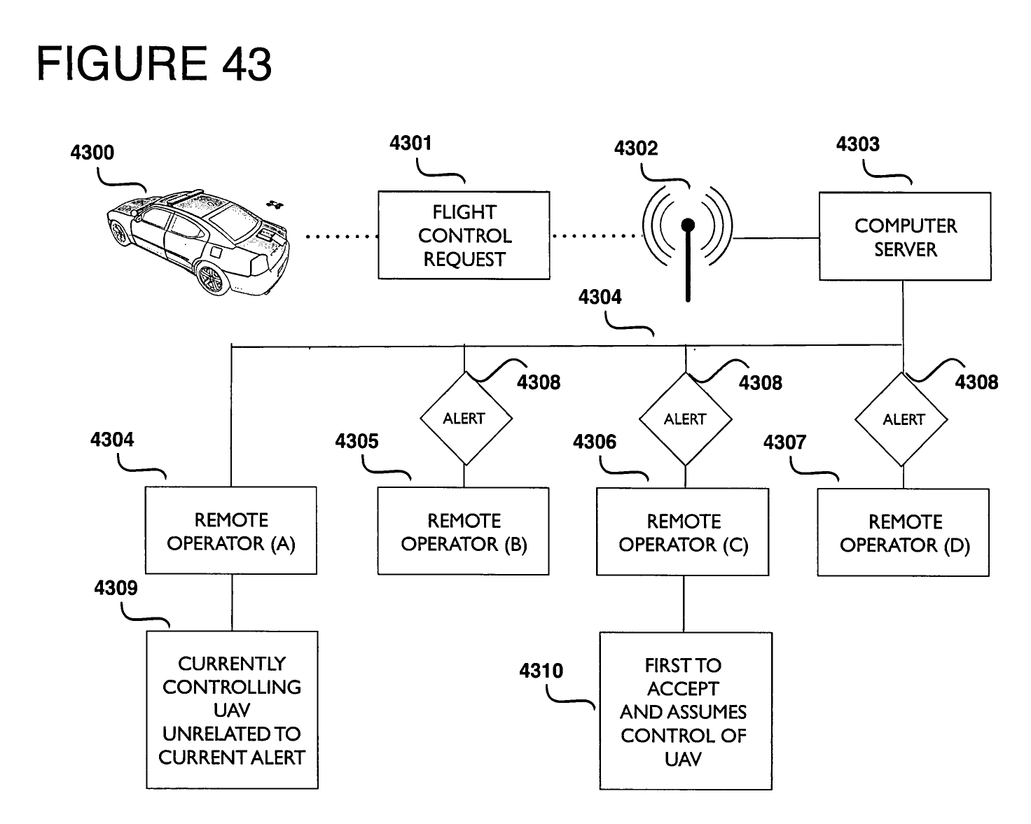

FIG. 43 is a flowchart illustration showing the process by which a request to assume control of a deployed UAV is handled by the present disclosure. The process begins when a local operator initiates a request for control 4301 during the deployment of an integrated UAV 4300. The request is transmitted wirelessly 4302 to the present disclosure's central computer server 4303 that processes the request. One or more remote operators 4304, 4305, 4306, 4307, which are linked to the central computer server 4303, are eligible to receive the incoming alert notification 4308 (depicted in FIG. 32) unless the operator is currently controlling a UAV deployed during an unrelated incident 4309. The first operator to acknowledge and accept the request for control 4310 then assumes control of the deployed UAV using the present disclosure's user interface (depicted in FIG. 28).

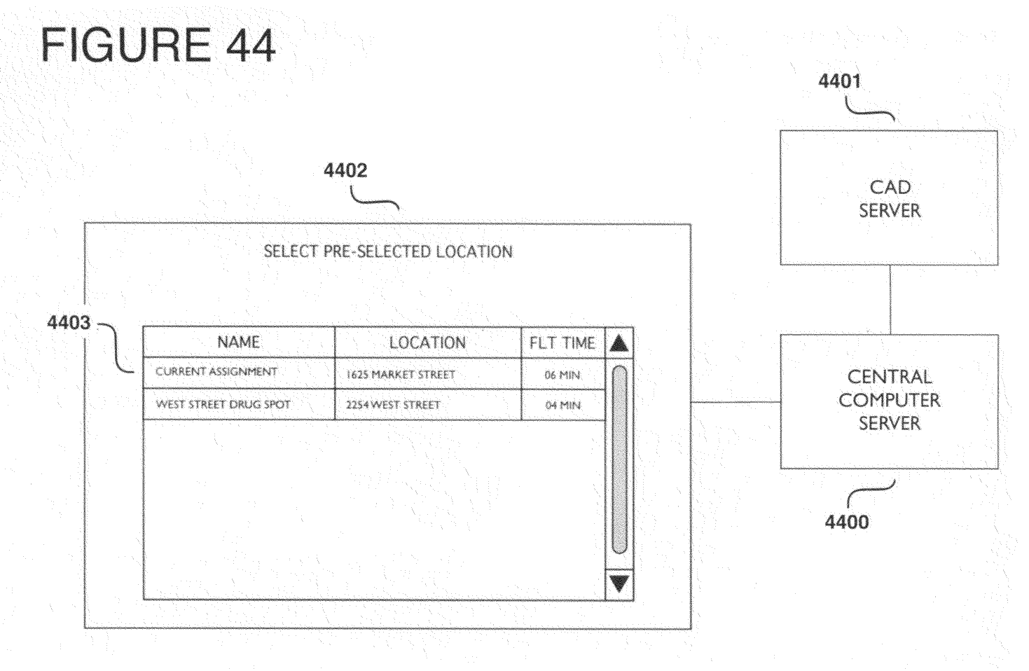

FIG. 44 is an illustration showing the integration and ability for an external data system (Computer Aided Dispatch) to provide pre-determined flight destinations. The present disclosure's central computer server 4400 maintains data communications with an external CAD system or similar system 4401 to provide information related to the geographic assignment (including but not limited to street address or GPS coordinates) of personnel who are in possession of an integrated, deployable UAV. This data is utilized by the present disclosure and displayed in the user interface 4402 to allow integrated UAVs to be quickly deployed to an assignment location 4403 in advance of the arrival of the deploying operator (detailed in FIGS. 16 and 17).

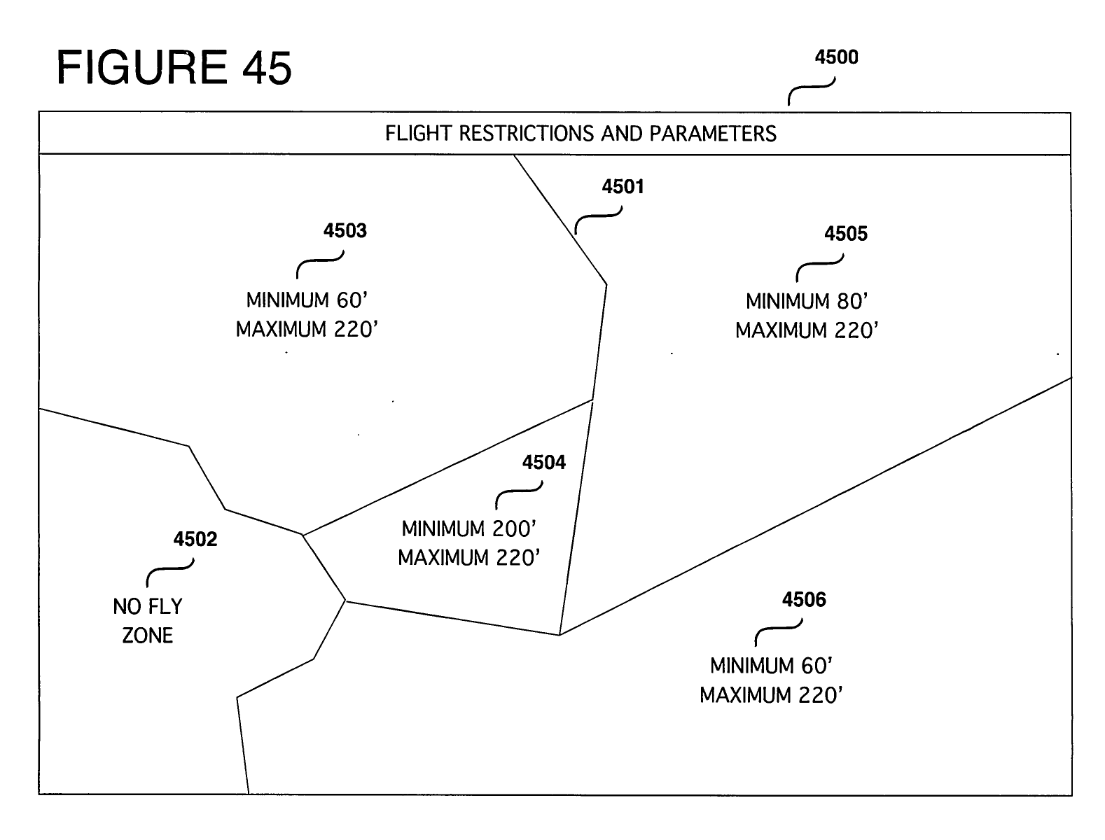

FIG. 45 is an illustration of the graphical user interface used to display the flight restrictions and parameters of integrated UAVs within defined geographical areas 4500. The illustration depicts the map of a geographical area that has been divided into five separate areas 4502-4506. The areas have been divided using geo-fencing 4501, which for the purpose of the present disclosure shall be defined as an area with an established virtual perimeter (using, but not limited to using GPS coordinates and/or parcel map data) for a real-world geographic area. The present disclosure's database is able to store and utilize parameters such as, but not limited to minimum altitude, maximum altitude, airspeed, and complete no-fly zone restrictions to control the deployment and location of integrated UAVs.

What is claimed is:

1. An apparatus, comprising:
an unmanned aerial vehicle contained within a housing,
wherein the housing is coupled to a vehicle;
wherein the housing and unmanned aerial vehicle respond to a wireless signal transmitted remotely to deploy such that the housing is opened and the unmanned aerial vehicle travels to a predetermined location.
